(19) United States
(12) Patent Application Publication
(10) Pub. No.: US 2009/0164564 A1
(43) Pub. Date: Jun. 25, 2009

(54) SYSTEM AND METHODS FOR MOBILIZING WEB CONTENT

(76) Inventor: Michael John WILLIS, Deerfield Beach, FL (US)

Correspondence Address: FOLEY & LARDNER LLP, 111 HUNTINGTON AVENUE, 26TH FLOOR, BOSTON, MA, 02199-7610, US

(21) Appl. No.: 12/209,977

(22) Filed: Sep. 12, 2008

Related U.S. Application Data
(63) Continuation-in-part of application No. 12/160,675.
Application No. 12/160,675 is a continuation-in-part of application No. 11/994,366, filed on Aug. 7, 2008.
(60) Provisional application No. 60/758,879, filed on Jan. 13, 2006.
(60) Provisional application No. 60/696,395, filed on Jul. 1, 2005.
(60) Provisional application No. 60/971,917, filed on Sep. 13, 2007.
(60) Provisional application No. 60/974,837, filed on Sep. 24, 2007.

(30) Foreign Application Priority Data
Jul. 3, 2006 (US) PCT/US2006/026066
Jan. 12, 2007 (US) PCT/US2007/000835

(51) Int. Cl. G06F 15/16; G06F 3/048

(52) U.S. Cl. 709/203; 715/760

(57) ABSTRACT

Devices and processes allowing users to identify media content suitable for mobilizing to a mobile device and facilitating selection and portability of such media content to the mobile device. A user viewing a web page opens a bookmark including a short first instruction configured to load at least one other instruction. The loaded instruction can be dynamically injected into the viewed web page. The injected instruction allows for the mobilization of media content.

### RELATED APPLICATIONS

This application:

is a continuation-in-part of U.S. patent application Ser. No. 12/160,675, filed on Jul. 11, 2008, which is a national stage application of International Patent Application serial number PCT/US2007/000835, filed on Jan. 12, 2007, which claims the benefit of priority to International Application serial number PCT/US2006/026066, filed Jul. 3, 2006, which claims the benefit of priority under 35 U.S.C. § 119(e) to U.S. Provisional Application No. 60/758,879, filed on Jan. 13, 2006 and U.S. Provisional Application No. 60/696,395, filed on Jul. 1, 2005;

is a continuation-in-part of U.S. patent application Ser. No. 11/994,366, filed on Dec. 31, 2007, which is a national stage application of International Patent Application serial number PCT/US2006/026066, filed on Jul. 3, 2006, which claims the benefit of priority under 35 U.S.C. § 119(e) to U.S. Provisional Application No. 60/758,879, filed on Jan. 13, 2006, and U.S. Provisional Application No. 60/696,395, filed on Jul. 1, 2005;

claims priority under 35 U.S.C. § 119(e) to U.S. Provisional Application No. 60/971,917, filed on Sep. 13, 2007, and

claims priority under 35 U.S.C. § 119(e) to U.S. Provisional Application No. 60/974,837, filed on Sep. 24, 2007;

which are incorporated by reference herein.

### COPYRIGHT NOTICE

A portion of the disclosure of this patent document contains material which is subject to copyright protection. The copyright owner has no objection to the facsimile reproduction by any-one of the patent document or the patent disclosure, as it appears in the Patent and Trademark Office patent file or records, but otherwise reserves all copyright rights whatsoever.

### BACKGROUND

In view of the explosive growth in the use of wireless telecommunication devices, users increasingly desire to transfer data files to their devices, such as to personalize the operation of the devices or consume entertainment, such as music and videos. One example is in the area of mobile telephones, where users are personalizing their phones by loading media files, such as graphic, video, and sound files onto their phones. For example, there is a growing trend for mobile phone users to use personalized ringtones when receiving a phone call rather than any default ringtones equipped with the phone.

The process for loading such data as a ringtone onto a user's phone can be tedious and expensive. Typically, a user relies upon alternative ringtones that may be offered by the mobile phone service provider. Consequently, the user is limited to a limited selection ringtones offered by the mobile service provider. In addition, the user must typically pay a monthly service fee in addition to a download fee for each ringtone in order to obtain ringtones from the mobile service provider.

### SUMMARY

One approach to mobilizing media content is a method. The method includes transmitting a bookmark to a requester device. The bookmark includes a first instruction for directing the requestor device to request a second instruction. The method further includes receiving a request from the requestor device for the second instruction. The request is based on the first instruction. The method further includes transmitting the second instruction in response to the request from the requestor device. The second instruction directs a modification of a user display associated with the requestor device to facilitate mobilization of media content.

Another approach to mobilizing media content from a web page is a method. The method includes visiting a web page using a web browser. The visited web page includes media content. The method further includes selecting while visiting the visited web page a bookmark stored in the web browser. The bookmark includes a first instruction processed in response to selection thereof. The method further includes obtaining a second instruction from a web accessible server based on the first instruction and loading into the web browser the second instruction in a context of the visited web page.

Another approach to mobilizing media content is a computer program product. The computer program product is tangibly embodied in an information carrier. The computer program product includes instructions being operable to cause a data processing apparatus to transmit a bookmark to a requestor device. The bookmark includes a first instruction for directing the requester device to request a second instruction. The computer program product further includes instructions being operable to cause a data processing apparatus to receive a request from the requestor device for the second instruction. The request is based on the first instruction. The computer program product further includes instructions being operable to cause a data processing apparatus to transmit the second instruction in response to the request from the requestor device. The second instruction directs a modification of a user display associated with the requestor device to facilitate mobilization of media content.

Another approach to mobilizing media content is a system. The system includes an access point module and a business logic module. The access point module transmits a bookmark to a requestor device. The bookmark includes a first instruction for directing the requester device to request a second instruction. The access point module further transmits the second instruction in response to a request from the requestor device. The second instruction directs a modification of a user display associated with the requester device to facilitate mobilization of media content. The business logic module receives the request from the requester device for the second instruction. The request is based on the first instruction.

Another approach to mobilizing media content is a system. The system includes a means for transmitting a bookmark to a requester device. The bookmark includes a first instruction for directing the requestor device to request a second instruction. The system further includes a means for receiving a request from the requestor device for the second instruction. The request is based on the first instruction. The system further includes a means for transmitting the second instruction in response to the request from the requestor device. The second instruction directs a modification of a user display associated with the requestor device to facilitate mobilization of media content.

In other examples, any of the approaches above can include one or more of the following features. A request for the bookmark is received from the requester device. The first instruction is smaller than the second instruction. The modification of the user display includes dynamically injecting a third instruction into the user display.

In some examples, the modification of the user display includes modifying a document object model (DOM) of a web page displayed on the user display. The bookmark includes an applet.

In other examples, media content associated with the user display is mobilized based on the second instruction. The mobilized media content is easily portable to a mobile device. The mobilized media content is transmitted to the mobile device associated with the requester device.

In some examples, the mobilizing the media content further includes transforming and/or modifying the media content. The media content is transformed from a first media format to a second media format based on configuration information associated with the mobile device.

In other examples, the configuration information associated with the mobile device is automatically determined based on a type of the mobile device, a setting of the mobile device, and/or a network associated with the mobile device.

In some examples, the media content is retrieved from a web page associated with the user display. A time interval of the media content is selected based on an audio segment and/or a video segment. The media content is transformed into the mobilized media content for the mobile device based on the selected time interval and/or configuration information associated with the mobile device.

In other examples, the time interval of the media content is selected based on the audio segment, the video segment, a user selection, a user preference, and/or a pre-defined media segment. The mobilized media content is stored.

In some examples, access to the stored mobilized media content is provided to a plurality of users via mobile devices. The media content includes an image, a video, audio, and/or a ringtone.

In other examples, the first instruction does not direct the modification of the user display associated with the requestor device to facilitate mobilization of media content. The user display displays a web page.

In some examples, a mobilization request for a specified media content is transmitted. The mobilization request includes information to associate the specified media content with a mobile storefront. The second instruction is dynamically injected into the visited web page based on the bookmark.

In other examples, the second instruction includes an applet. The applet includes javascript.

In some examples, a media processing module mobilizes the media content based on the second instruction. The mobilized media content is easily portable to a mobile device.

In other examples, the access point module transmits the mobilized media content to the mobile device associated with the requestor device. The mobile device is the same as the requestor device.

In some examples, a media processing module retrieves the media content from a web page associated with the user display. The media processing module selects a time interval of the media content based on an audio segment and/or a video segment. The media processing module transforms the media content into the mobilized media content for the mobile device based on the selected time interval and/or configuration information associated with the mobile device.

In some examples, a storage module stores the mobilized media content.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects of this invention, the various features thereof, as well as the invention itself, may be more fully understood from the following description, when read together with the accompanying drawings in which:

FIG. 1 illustrates an exemplary system for the mobilization of media content;

FIG. 2 illustrates another exemplary system for the mobilization of media content;

FIG. 3 illustrates another exemplary system for the mobilization of media content;

FIG. 4 depicts a flow chart of the mobilization of media content;

FIG. 5 depicts another flow chart of the mobilization of media content;

FIG. 6 depicts another flow chart of the mobilization of media content;

FIG. 7 depicts a flow chart of the mobilization of media content through a mobilization media server;

FIG. 8 depicts an exemplary screenshot of a mobile storefront;

FIG. 9 illustrates an exemplary screenshot of a third party web page;

FIG. 10 is an illustration of an exemplary third party web page providing a bookmark;

FIG. 11 is an illustration of an exemplary web page including content for mobilizing;

FIG. 12 is an illustration of the web page of FIG. 11 including a bookmark to launch additional mobilization functionality;

FIG. 13 is an illustration of the target web page of FIG. 11 illustrating launched exemplary mobilization functionality;

FIG. 14 is an illustration of another exemplary mobilization functionality for the web page of FIG. 11; and

FIG. 15 depicts an exemplary schematic diagram of a database schema utilized in the storage of media content.

### DETAILED DESCRIPTION

### General Overview of Mobilization Technology

As a general overview of the mobilization technology, media content (e.g., audio content, video content, pictures, wallpaper, other types of content, etc.) is mobilized (e.g., created, deployed, spliced, etc.) for use with mobile devices (e.g., cell phone, personal digital assistant, etc.). The media content is mobilized by the selection of a bookmark (e.g., web browser saved url, content-based menu, etc.) by a user while utilizing a web browser and/or any other type device that can view media content. The selection of the bookmark by the user causes the processing of a first instruction which obtains a second instruction (e.g., javascript instructing the download of an java applet, html redirect to download a script, etc.). The second instruction is loaded into the web browser and provides an interface for mobilization of the media content by the user (e.g., select, preview, send, etc.).

In some examples, the media content is audio content and/or video content with sound that can be processed into segments that are usable as ringtones. Ringtones can be, for example, created by extracting segments from source audio and/or video files.

In other examples, the users identify media content suitable for porting to a mobile device and facilitate the selection and portability of such media content to the mobile device. In this sense, it can be said that the user “mobilizes” existing media content for easy portability to the mobile device. Such portability can be accomplished using a bookmark and/or a mobile storefront through which assets identified on existing web pages can be accessed by mobile users. The storefront can be created at least in part from assets obtained from existing web pages. For example, pictures, videos, and/or audio clips on a web page (or linked to from the web page) represent assets that can be used as resources available through a mobile storefront.

In some examples, the media content is supplied by end users and/or content owners. These audio or video files can be, for example, provided by a third party, preferably an authorized third party such as a band that wants to provide songs to fans, and such files are supplied for example, over a network. Regardless of source, the media content can be dynamically processed into segments, and the segments can be converted into a format suitable for use with a mobile phone.

In other examples, ringtones are deployed to mobile phones using mobile messaging (e.g., SMS, MMS, etc.) and/or internet technologies (e.g., WAP, XHTML, etc.). See for example, United States Patent Application 2006/0015649 (incorporated herein by reference in its entirety), which describes a system that permits a user to customize and distribute the media content over a network from a first network device, such as a personal computer, to a second network device, such as a mobile phone. Prior to distributing the media content, the user can use the first network device to easily and automatically convert the media content from a first format to a second format that is recognizable and usable by the mobile device. The user can easily and quickly access a media file and convert the entire file, or a portion thereof, to the second format. For example, the user can upload an audio file in mpeg format from a desktop computer and convert the audio file into wave format.

In some examples, the first instruction is smaller than the second instruction. In other words, the first instruction is advantageously small (e.g., five lines, ten lines, etc.) for storage and/or processing by the mobile devices and/or the computing devices. In other examples, the first instruction is the same size as the second instruction due to the scalability and/or flexibility of the system.

The system and method for the mobilization of media content is advantageously different from prior ringtone generation and distribution systems. An advantage of the mobilization of media content is that the ringtones can be custom created from source audio files, i.e., those that are supplied by users, instead of relying on a centralized catalog of available titles which increases the amount of media content available for use by the user. Another advantage is that appropriate segments of sound files can be dynamically chosen for use as ringtones, and the audio can be dynamically converted into a format appropriate for the target device (i.e., the mobile device). An additional advantage is that the mobilization can be customized for any type of service provide and/or mobile device which enables independence from the carrier used to provide cellular service to the user, and it requires no changes to carriers' networks.

In other examples, the mobilization of media content includes support for many different media formats using similar basic algorithms and techniques. For example, videos and/or full-track audio content can be mobilized by the mobilization system into ringtones. As another example, video and/or still images can be mobilized into wallpaper. Thus, the creation and delivery of a ringtone is not intended to be limited to audio, and the original source of the resultant content need not be audio file.

In some examples, discrete files are downloaded to mobile devices. The mobilization system can, for example, deliver a continuous stream of data in real time (or near real time) to the mobile device. Streaming media is an attractive solution when delivering content such as video content that is intended to be viewed immediately. The streaming can utilize a dedicated streaming server using technologies such as Real Time Streaming Protocol (RTSP).

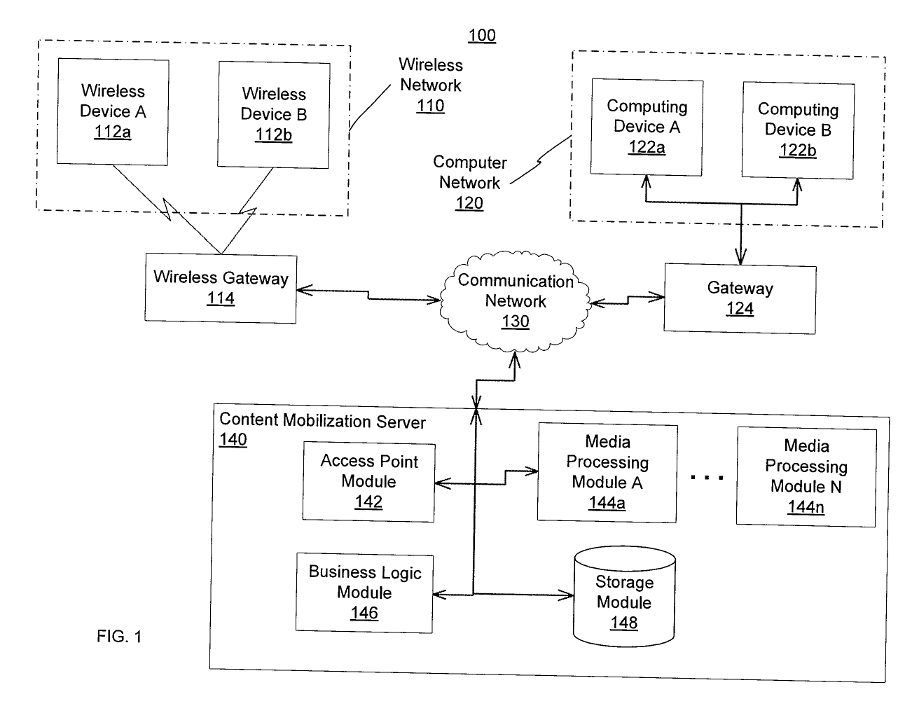

FIG. 1 illustrates an exemplary system 100 illustrating mobilization of media content. The system 100 includes a wireless network 110, a computer network 120, a communication network 130, and a content mobilization server 140. The wireless network 110 communicates via a wireless gateway 114 with the communication network 130. The computer network 120 communicates via a gateway 124 with the communication network 130. The wireless network 110 includes a wireless device A 112a and a wireless device B 112b (generally 112). The computer network 120 includes a computing device A 122a and a computing device B 122b (generally 122). The content mobilization server 140 includes an access point module 142, a media processing module A 144a through a media processing module N 144n, a business logic module 146, and a storage module 148.

Each wireless device 112 communicates via the wireless gate 114 and the communication network 130 to the content mobilization server 140. Each computing device 122 communicates via the gateway 124 and the communication network 130 to the content mobilization server 140.

For example, a user utilizing the computing device A 112a (in this example, a desktop computer; also referred to as a requestor device) downloads a bookmark into the web browser (in this example, Microsoft® Internet Explorer® available from Microsoft Corporation) installed on the computing device A 112a. The user browses the world wide web and visits a web page with media content (in this example, image files). After the user identifies an image file that the user wants to mobilize, the user selects the bookmark (in this example, a favorite) stored in the web browser. The bookmark includes a first instruction (in this example, five lines of javascript) which requests a second instruction (in this example, a java program) from the content mobilization server 140.

As a further example, the second instruction is injected into the visited web page. In other words, the web browser loads the java program within the visited web page, so that the user controls for mobilization of the media content are integrated into the web page. The user controls can, for example, include preview, buy, customize, send to mobile device, and/or any other type of control utilized for media content. After the second instructions is injected into the visited web page, the user can select the media content (in this example, an image file) and select a user control (in this example, send to mobile device). The request for mobilization is sent to the content mobilization server 140. The content mobilization server 140 obtains the media content based on the request (e.g., accesses the web page and downloads the media content, requests the media content from a library of media content, etc.). The content mobilization server 140 mobilizes the media content based on information associated with the wireless device A 112a (in this example, a cell phone; also referred to as a mobile device). After mobilization, a link to the mobilized media content and/or the mobilized media content is sent to the wireless device A 112a which can then use the mobilized media content (e.g., ringtone, background, theme song, etc.). The storage module 148 can store the mobilized media content, the un-mobilized media content, and/or any other information associated with the mobilization of the media content. The storage module 148 can also provide the stored mobilized media content to a plurality of devices (e.g., wireless device, computing device, etc.).

Although FIG. 1 illustrates the system 100 with separate computing devices 122 and wireless devices 112, the system 100 can mobilize media content using only a single device. In other words, a mobile device can select media content for mobilization via a first instruction and a second instruction, and the same mobile device can receive the mobilized media content.

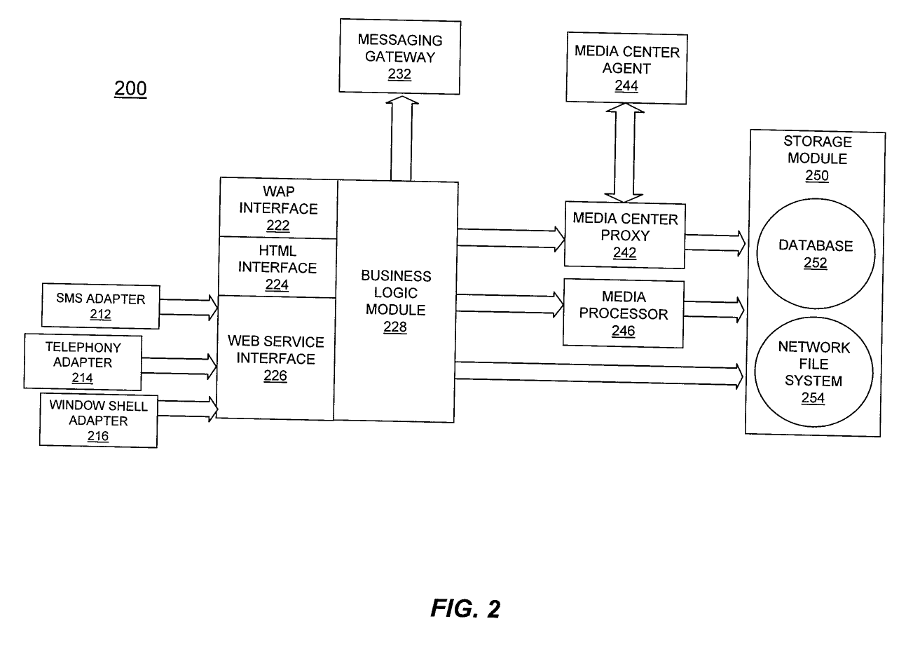

FIG. 2 illustrates another exemplary system 200 for media content mobilization. The system 200 includes an SMS adaptor 212, a telephony adaptor 214, a window shell adaptor 216, and a web service interface 226. The SMS adaptor 212, the telephony adaptor 214, and the window shell adaptor 216 communicate via the web service interface 226. The system 200 further includes a wireless access point (WAP) interface 222, an HTML interface 224, and a business logic module 228.

The WAP interface 222 receives requests for bookmarks, second instructions, and/or the mobilization of media content from any type of device utilizing a wireless access protocol (e.g., cell phone, personal digital assistant, etc.). The HTML interface 224 receives requests for bookmarks, second instructions, and/or the mobilization of media content from any type of device utilizing HTML (e.g., a device utilizing a web browser, etc.). The web service interface 226 receives requests for bookmarks, second instructions, and/or the mobilization of media content from any type of device utilizing a web service (e.g., a device utilizing a service oriented application protocol, etc.). Although FIG. 2 does not illustrate two-way communication with the WAP interface 222, the HTML interface 224, and the web service interface 226, these interface can receive and/or transmit information to/from devices. The WAP interface 222, the HTML interface 224, and the web service interface 226 communicate with the business logic module 228 to mobilize media content.

The business logic module 228 communicates with a messaging gateway 232, a media center proxy 242, and a media processor 246. The business logic module 228 communicates with the storage module 215 to store and/or process media content. The messaging gateway 232 communicates via different messaging mechanisms with a requester device (not shown) and or any other type of computing device (e.g., mobile device, etc.). The media center proxy 242 communicates with the media center agent 244. The media center agent 244 is utilized to upload media content to the media center proxy 242.

The media processor 246 processes the media content for storage in the storage module 250. The storage module 250 includes a database 252 and the network file system 252. The database 252 stores media content and/or other types of information associated with the media content. The network file system 254 stores the media content and/or other types of information associated with the media content for access by other devices on or associated with a network (not shown).

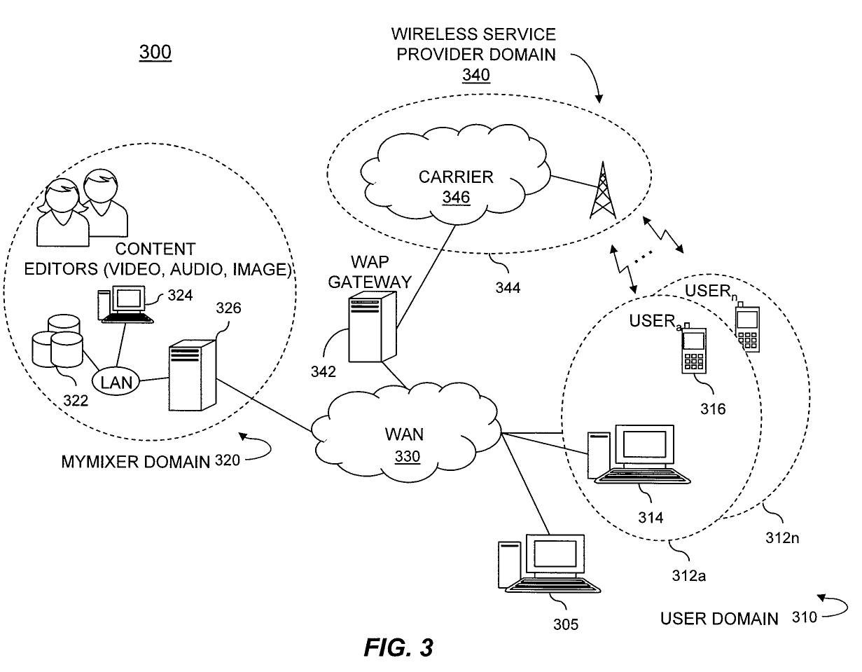

FIG. 3 illustrates another exemplary system 300 for mobilizing media content. The system 300 includes a computing device 305, a user domain 310, a mymixer domain 320, a wireless service provider domain 340, a WAP gateway 342, and a wide area network (WAN) 330. The user domain 310 includes a plurality of users 312a through 312n (generally 312). Each user 312 is associated with a requester device 314 and a mobile device 316. The user 312 utilizes the requestor device 314 to browse the web and select media content for mobilization. The mobile device 216 receives the mobilized media content and uses the mobilized media content (e.g., ringtone, wallpaper, etc.).

The mymixer domain 320 includes a storage device 322, a computing device 324 and a gateway 326. The storage device 322 stores un-mobilized media content, mobilized media content, mobile device information, user information (e.g., location, preferences, etc.), and/or any other type of information associated with the mobilization of media content. The computing device 324 operates as a content mobilization server and/or an interface for monitoring and/or administrating other content mobilization server (e.g., geographically distributed content mobilization servers, a plurality of content mobilization servers, external content mobilization servers, etc.). The gateway 326 provides a network interface between the WAN 330 and the local area network (LAN) in the mymixer domain 320.

The wireless service provider domain 340 includes a carrier network 346 which communicates with the users via a wireless network 344. The WAP gateway 342 is utilized to communicate between the wireless service provider domain 340 and the wide area network 330. Although FIG. 3 illustrates a single carrier network 346 within the wireless service provider domain 340, the system 300 can include a plurality of carrier networks which can be inter-connected. In this example, each carrier network can be connected to the WAP gateway 342 and/or each carrier network can be connected to its own WAP gateway.

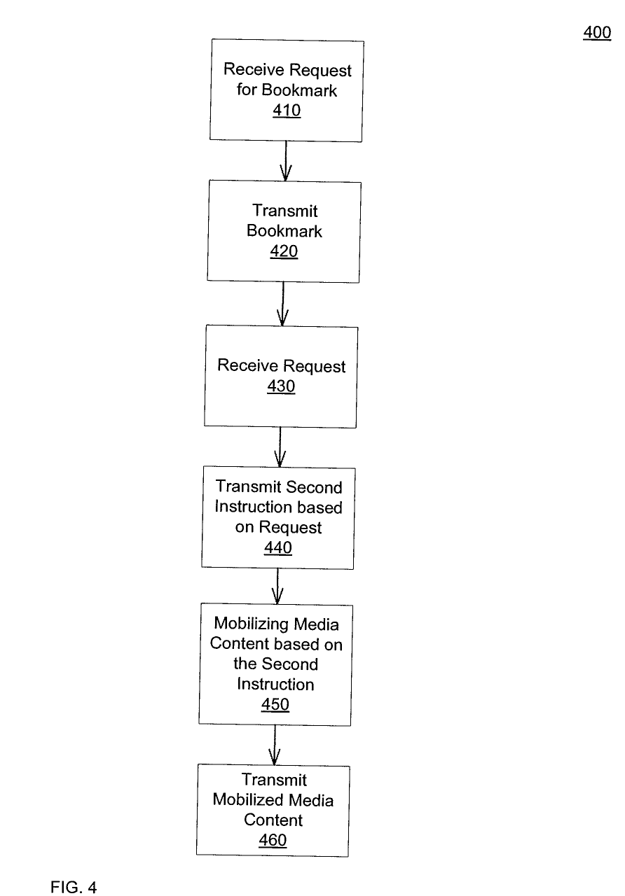

FIG. 4 depicts a flowchart 400 of the mobilization of media content through the system 100 of FIG. 1. The access point module 142 receives (410) a request from a bookmark from a wireless device 112. The access point module 142 transmits (420) the bookmark based on the request. The access point module 142 receives (430) a request for a second instruction. The access point module 142 transmits (440) the second instruction based on the request for the second instruction. The media processing module 144 mobilizes (450) the media content based on the second instruction. The media processing module 144 transmits (460) the mobilized media content to the requesting device.

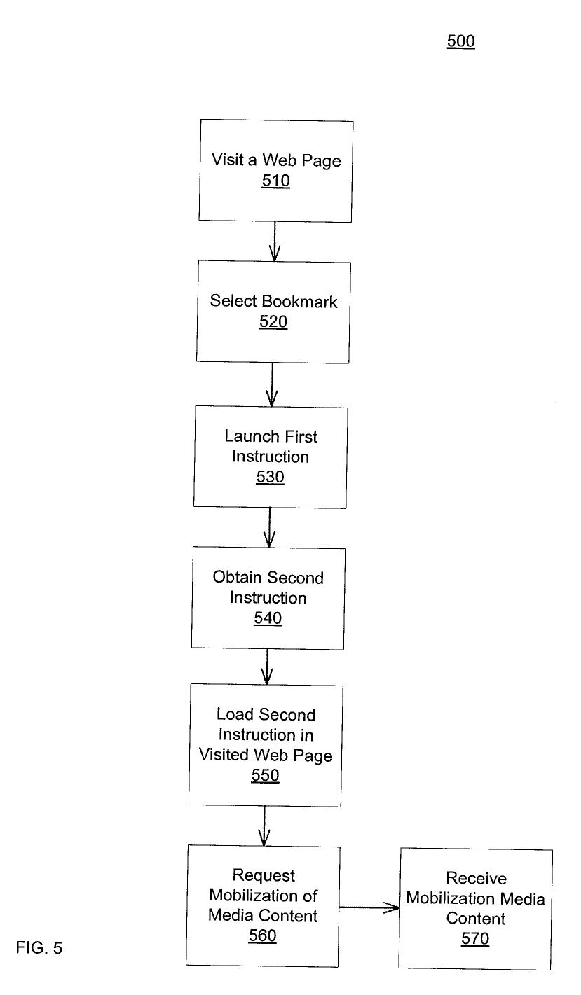

FIG. 5 depicts another flowchart 500 of the mobilization of media content through the system 100 of FIG. 1. The wireless device 112 visits (510) a web page. The web page can be located at a third party web accessible server (not shown) and/or any other computing device (not shown). The user utilizing the wireless device 112 selects (512) a bookmark stored in a web browser associated with the wireless device 112. The bookmark launches (530) the first instruction associated with the bookmark based on the selection of the bookmark. The wireless device 112 obtains (540) the second instruction from the content mobilization server 140 via communication to the wireless gateway 114 and the communication network 130. The wireless device 112 loads (550) the second instruction in the visited web page. The user utilizing the web browser associated with the wireless device 112 requests (560) the mobilization of the media content via communication with the media processing module 144. The wireless device 112 receives (570) the mobilized media content from the media processing module 144.

In some examples, the first instruction and the second instruction modify the visited web page. In other examples, the first instruction does not modify the visited web page and only the second instruction modifies the visited web page.

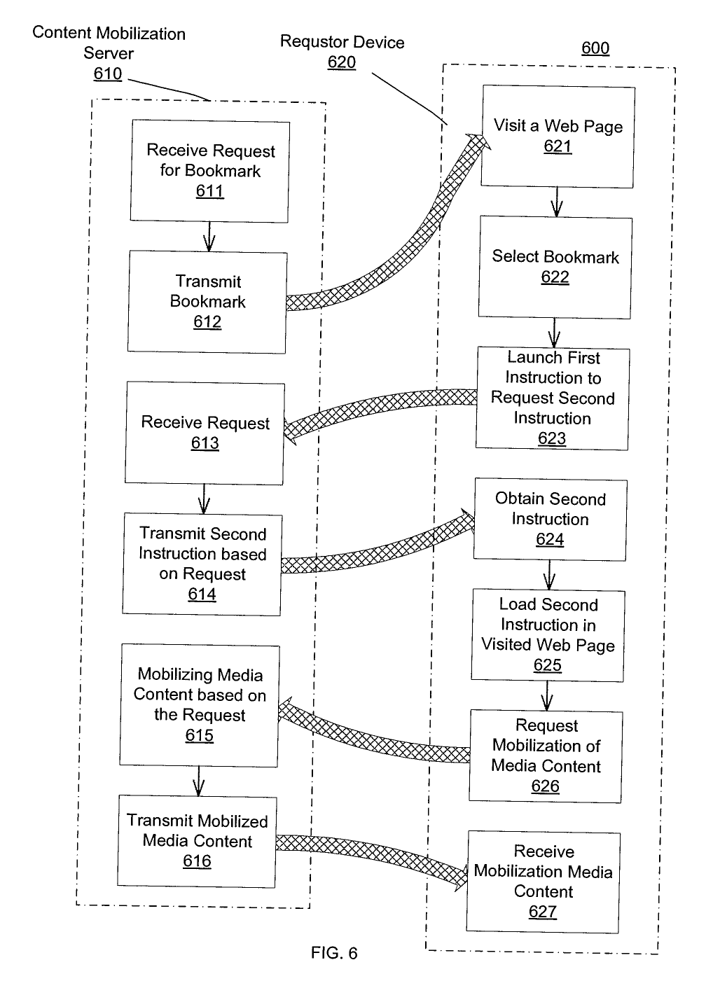

FIG. 6 depicts another flowchart 600 illustrating the mobilization of media content. The flowchart 600 includes a content mobilization server 610 and a requester device 620. The content mobilization server 610 receives (611) a request for a bookmark from the requester device 620. The content mobilization server 610 transmits (612) the bookmark based on the request. The requester device 620 loads the bookmark into a web browser associated with the requester device 620. A user associated with the requester device 620 utilizing a web browser visits (621) a web page. The user utilizing the web browser selects (622) the bookmark. The requester device 620 launches (623) a first instruction associated with the bookmark to request a second instruction.

The content mobilization server 610 receives (613) the request for second instruction. The content mobilization server 610 transmits (614) the second instruction based on the request of the requester device 620. The requester device 620 obtains (624) the second instruction from the content mobilization server 610. The requester device 620 loads (625) the second instruction in the visited web page. The user utilizing the web browser associated with the requester device 620 requests (626) mobilization of media content on the web page. The content mobilization server 610 receives the request for mobilization and mobilizes (615) the media content based on the request. The content mobilization server 610 transmits (616) the mobilize media content to the requester device (620). The requester device 620 receives (627) the mobilized media content and utilizes the mobilized media content.

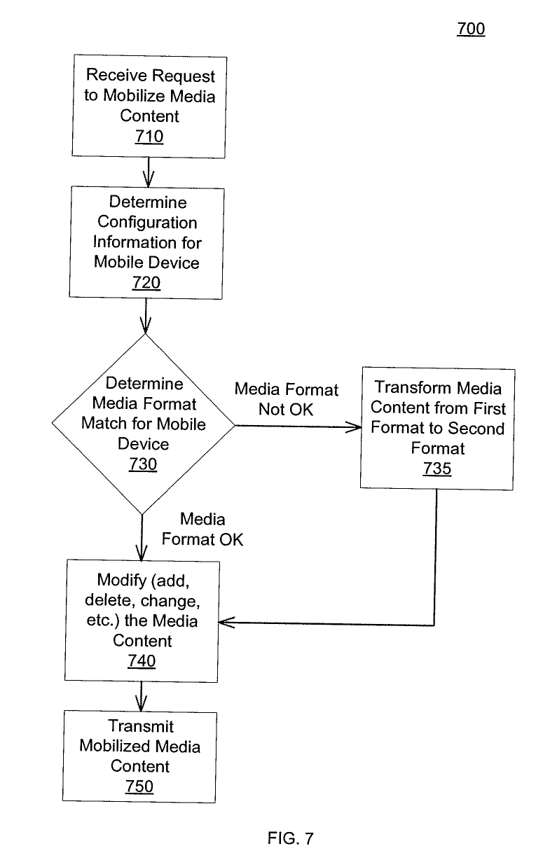

FIG. 7 depicts another flowchart 700 of the mobilization of media content through the content mobilization server 140, FIG. 1. The content mobilization server 140 receives (710) a request to mobilize media content. The media processor module 144 determines (720) configuration information for a mobile device (e.g., type, network, etc.) associated with the requestor device. The media processor module 144 determines (730) if there is a media format match for the mobile device. In other words, the media processor 144 determines if the media in a format (e.g., mpeg, wav, jpg, gif, etc.) compatible with the mobile device. If the media format is not compatible, the media processor module 144 transforms (735) the media content from the first format (i.e., current format) to a second format (i.e., a format compatible with the mobile device). If the media format is compatible and/or after the transformation of the media content from first format to second format, the media processor module 144 modifies (740) the media content. The modification of the media content can include adding, changing, deleting, re-ordering, re-sizing, compressing, and/or any other type of modification to the media content. The content mobilization server 140 transmits (750) the mobilized media content to the wireless device 112 and/or the storage module 148.

In some examples, the media processor module 144 transforms (735) the media content from the first format to a second format based on configuration information associated with the mobile device. The configuration information can include a type of the mobile device, a setting of the mobile device, a network associated with the mobile device, and/or any other information associated with a mobile device.

In other examples, the media processor module 144 modifies (740) the media content based on a time interval associated with the media content and/or a segment associated with the media content. The media processor module 144 can select the time interval based on the segment associated with the media content (e.g., an audio segment, a video segment, etc.), a user selection (e.g., selection from the user interface, email selection, etc.), a user preference (e.g., information stored in the system, dynamically generated user preferences, etc.), the configuration information associated with the mobile device, and/or any other information associated with the mobilization of media content.

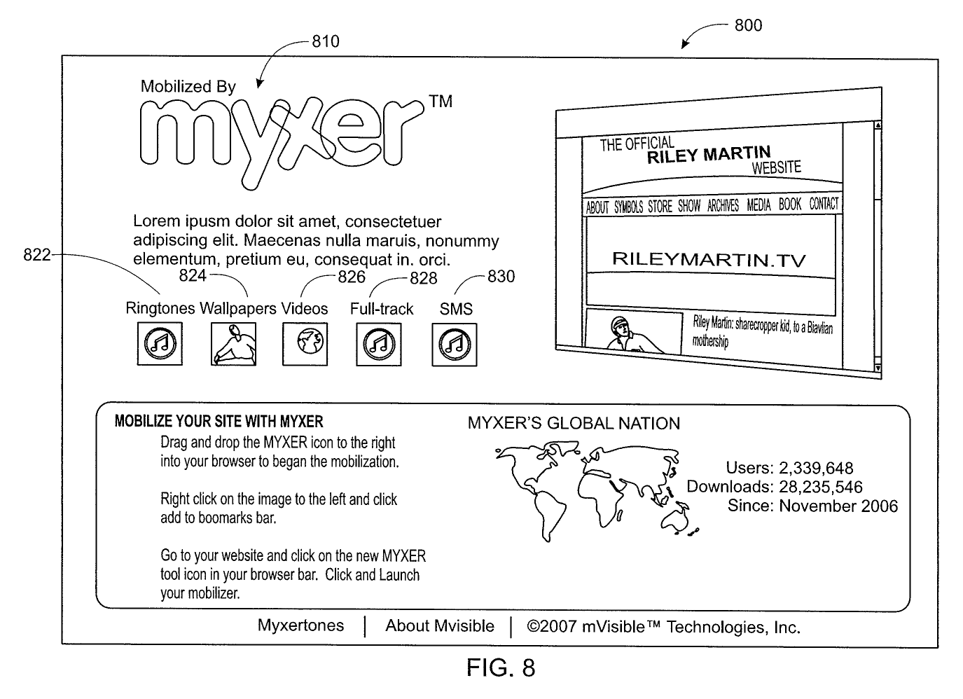

FIG. 8 depicts an exemplary screenshot of a mobile storefront of the content mobilization server 140 of FIG. 1. The screenshot 800 includes an illustration of the mobilization by the technology as described herein (i.e., the technology enabling the mobilization of media content). The screenshot 800 includes the mobile storefront. The mobile storefront includes ringtones 822, wallpapers 824, videos 826, full-track audio 828, and short message service (SMS) 830.

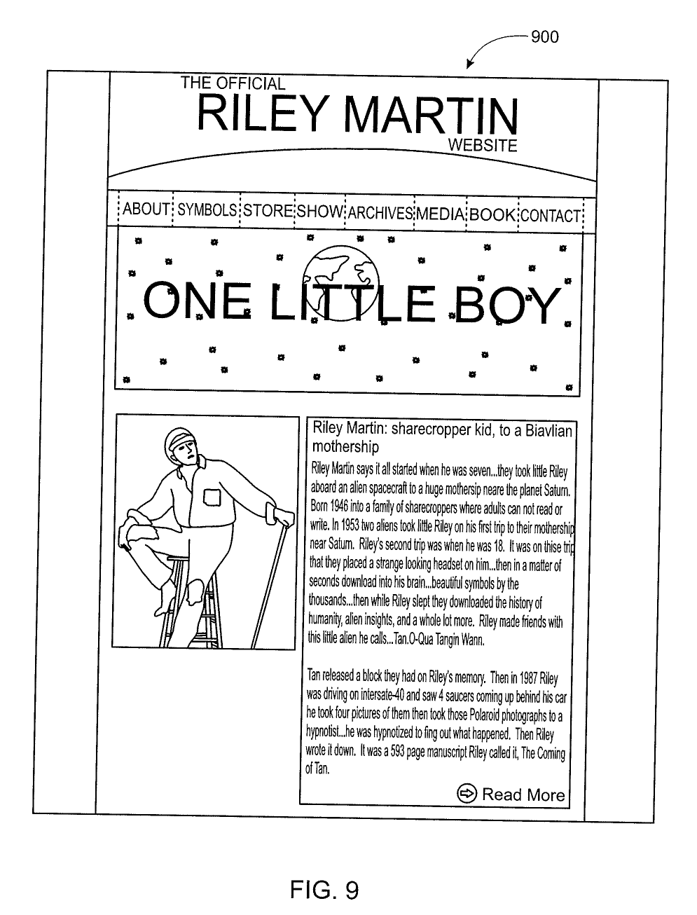

FIG. 9 illustrates an exemplary screenshot 900 of a third party website. The third party website includes media content that can be mobilized for a mobile device.

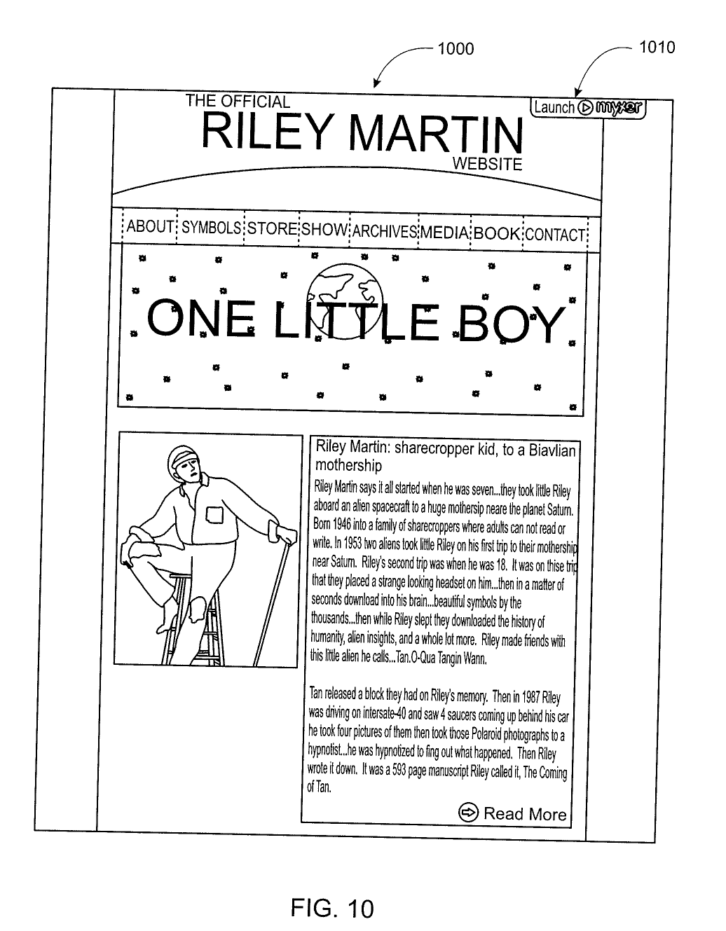

FIG. 10 illustrates another exemplary screenshot 1000 that includes a bookmark 1010 which enables the mobilization of media content. The user associated with the requester device can launch the bookmark 1010 by clicking on the bookmark to launch the first instruction. Although FIG. 10 illustrates the bookmark 1010 embedded into the top of the website, the bookmark 1010 can be a context-sensitive menu, a pop-up box, and/or any other type of function that can embed and/or utilize a bookmark.

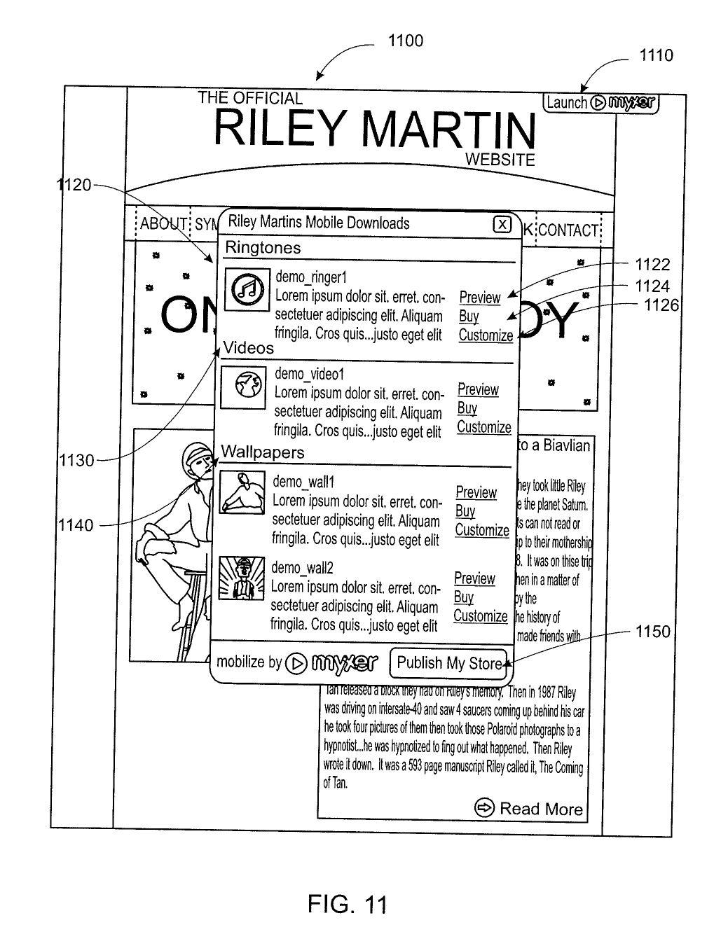

FIG. 11 depicts another exemplary screenshot 1100 of the mobilization of media content. The screenshot 1100 depicts a bookmark 1110 and second instructions 1120 used to mobilize media content. The second instructions 1120 are utilized to mobilize media content and include a preview button 1122, a buy button, 1124, a customize button 1126, and Publish My Store button 1150. The second instructions 1120 are injecting into the web page depicted by the screen shot 1100. The injection of the second instructions 1120 includes analyzing the web page to identify media content, determining types of mobilization available for each identified media content, and/or providing a user interface for the selection of mobilizations of the media content. In this illustration, the second instructions identified ringtones 1120, video 1130, and wallpapers 1140 for mobilization and provided the illustrated user interface accordingly.

The user associated with the requester device can request the media content illustrated in the screenshot 1100. For example, the user can select the preview button 1122 to preview the demo ringer audio ringtone. As another example, the user can select the customize button for the video 1130 to customize the video.

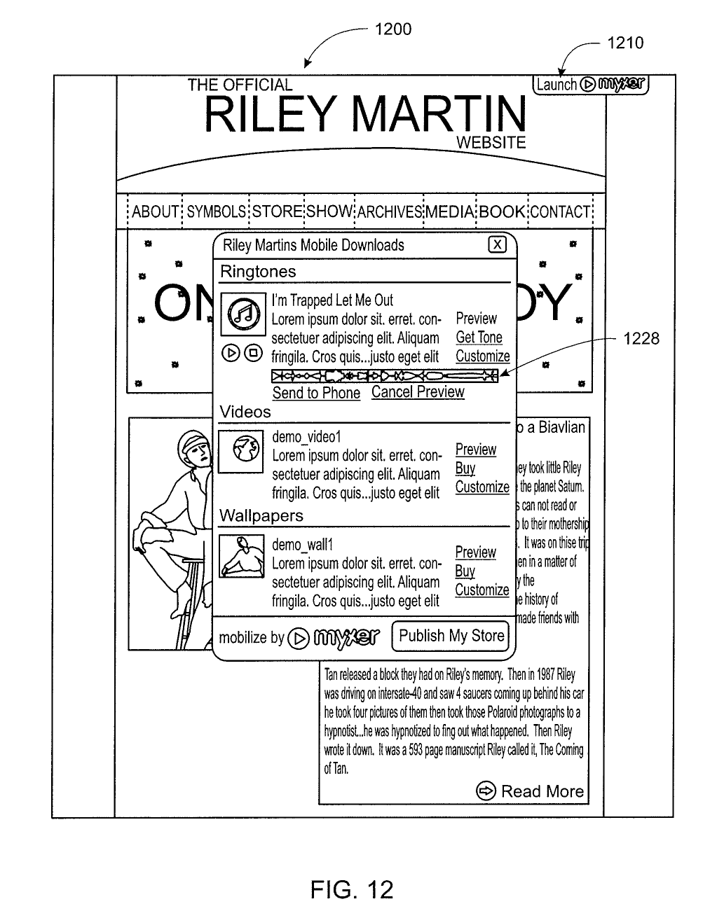

FIG. 12 depicts another exemplary screen shot 1200 of the mobilization of media content. The screen shot 1200 illustrates the bookmark 1210 that enables the launching of the second instructions. The screen shot 1200 further depicts the preview of the ringtone as illustrated by the preview user interface 1228.

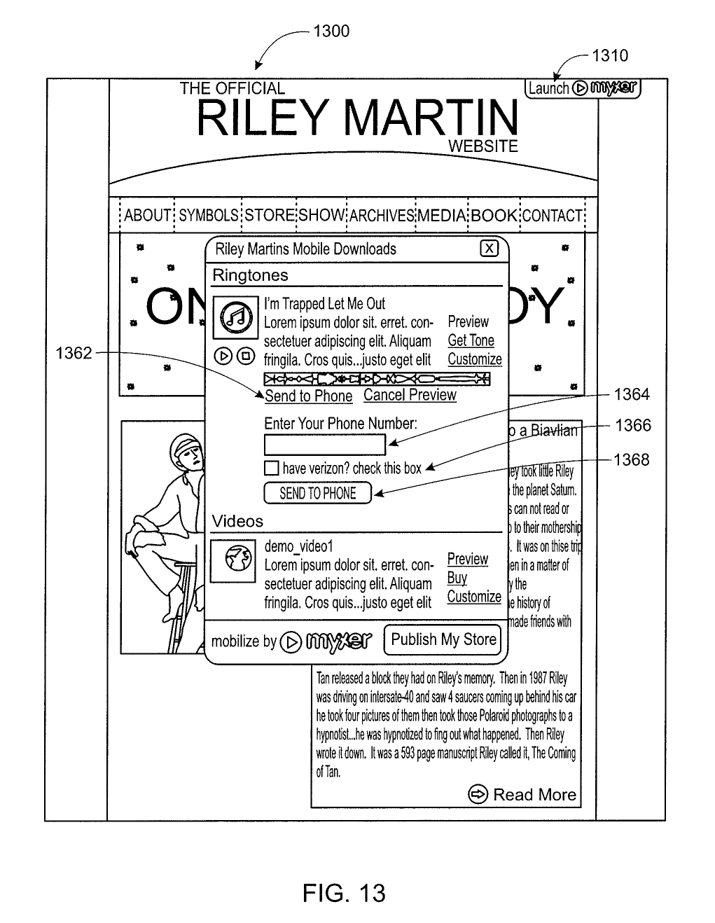

FIG. 13 depicts another exemplary screenshot 1300 that includes a send to my phone 1362 button feature. The screenshot 1300 illustrates the bookmark 1310 that enables the launching of the second instruction. The screenshot 1300 further illustrates a phone number field 1364, an information field regarding the mobile device network 1366, and a send to phone button 1368. To receive the mobilized ringtone, the user can enter in the mobile device phone number in the phone number field 1364, input mobile device network information in the information field 1366, and click on the send to phone button 1368. The provided information is transmitted to the content mobilization server 140 of FIG. 1 which mobilizes the selected ringtone based on the provided information.

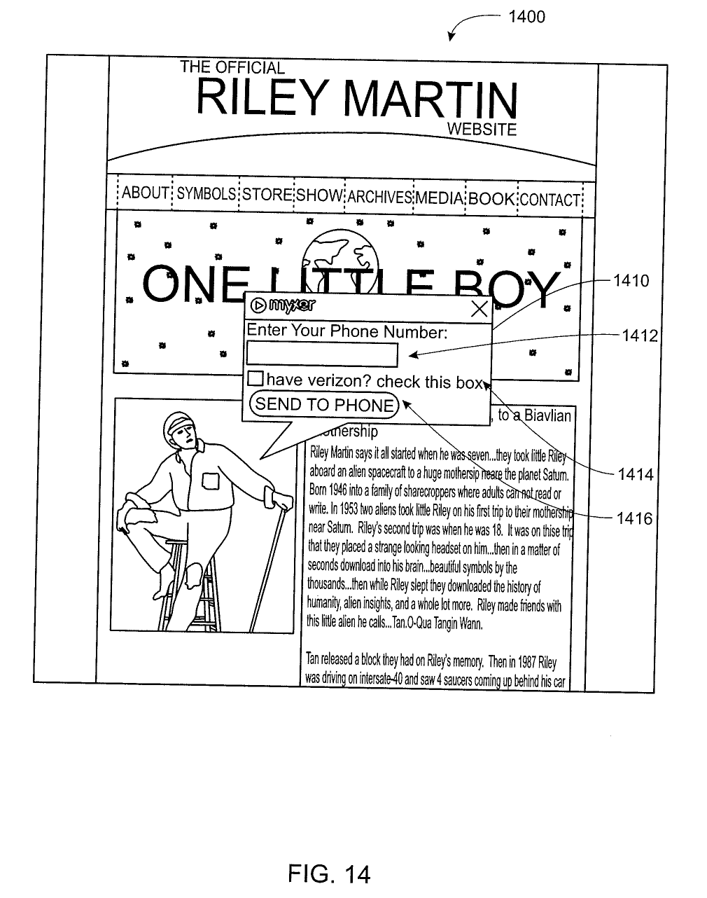

FIG. 14 illustrates another exemplary screenshot 1400. The screenshot 1400 depicts a shortcut send to phone dialogue 1410. The information in the phone dialogue 1410 includes enter your phone number field 1412, information about the mobile device network field 1414, and a send to phone button 1416. In some examples, the shortcut mobilization feature depicted in the screenshot 1400 is accessed utilizing a context-sensitive menu in a web browser. In other examples, the shortcut media content mobilization shortcuts 1410 is started utilizing a saved favorite in the web browser.

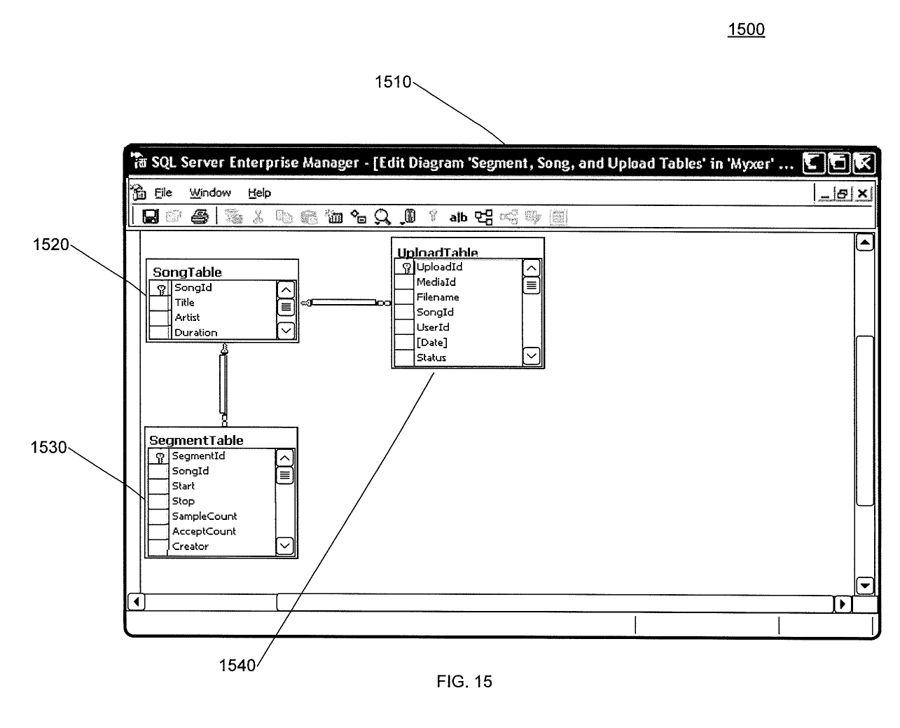

FIG. 15 depicts an exemplary schematic diagram 1500 of a database schema 1510 utilized in the storage of media content. The database schema 1510 includes a song table 1520, a segment table 1530, and an upload table 1540. The song table 1520 stores information about songs mobilized by the content mobilization system. The segment table 1530 stores information about the segments in each song that are utilized by the mobile devices (e.g., which three second segment in a ninety second song is utilized as a ringtone, etc.). Although FIG. 15 illustrates three tables, the database schema 1510 can utilize any number and/or configuration of tables for the storage of mobilized media content.

In some examples, every time a new file is uploaded by a user to be spliced and used as a ringtone, a record is created in the upload table 1540. The file is processed by software running on the content mobilization server 140 to identify the song it contains. Note that the same song may be encoded in many different ways, and there are many techniques for determining the title, artist, and other properties of a song. Some files (like many MP3's) contain the information in a header, or in another specific part of the file. Sometimes the information is contained in other metadata associated with the file. In some cases, it may be necessary to use a service such as CDDB to identify the song based on a small sample clip of its audio. In any case, each uploaded file is represented by the upload table 1540. The song it contains is identified, and the upload record is associated with the song record (in the song table 1520) representing that song. If no song record for the identified song already exists, it is created. Song records are unique, in that there will only be a single song record in the song table 1520 for a given song, regardless of the number of times it has been uploaded by users.

The part of the song to use as a ringtone is identified by a segment record, which is a database record stored in the segment table 1530. Start and Stop times that identify the portion of the song specified by the segment, SampleCount and AcceptCount fields used to track the ‘score’ of the segment, and the identity of the user that first created the segment can be stored in the segment table 1530.

In other examples, other information such as fade-in/fade-out could be specified in a segment table 1530, and a segment record could otherwise be enhanced to represent a shortened version of a song. For example, it might actually describe two or more distinct sections of the song, along with information on how they should be connected or fused. Because a ringtone segment is often quite short compared to the entire song, a desirable ringtone segment might be one that combines multiple sections of the same song into a compressed form.

Web Browser Extension

A web browser extension can be, for example, provided to work with browsers, such as Internet Explorer (IE), Firefox, and/or any other web browser. The web browser extension can add a menu option to the context menu of the web browser. In this example, the context menu is a list of options displayed in a browser screen when a user clicks the right mouse button on an image in the browser. For example, when the context menu is invoked over an image on any web page, an option “MYXER—sent to phone” is provided to send a copy or rendition of the image to a mobile device.

In some examples, the ability to forward web content to a mobile device can be provided without having to add server-side scripts to a web page in order for the web browser extensions to work. In this example, the web browser extensions can work with any standard HTML page, allowing users to send any image they see in their web browser to their mobile phone using MYXER's online functionality.

For example, the web browser extension can be installed on Internet Explorer utilizing a well-known technique, by creating a registry key (also referred to as the first instruction): HKEY_CURRENT_USER\Software\Microsoft\Internet Explorer\MenuExt\MYXER—Send image to phone! With a “default” value of REG_SZ “http://www.myxertones.com/magic/ie/v1.0/”, and a “Contexts” value of REG_BINARY 0×02. This causes the IE browser to display a “MYXER—Send image to phone!” menu item whenever the user right mouse clicks on an image in their browser.

As a further example, when the user selects the “Send image to phone” menu item, the script at . . . /magic/ie.aspx (also referred to as the second instruction) is retrieved. Exemplary script is provided below:

<script type=“text/javascript” defer=“defer”>

var win = external.menuArguments;
var a = win.location.hostname;
var u = win.event.srcElement.src;
var t = win.event.srcElement.alt;
var p = “?u=” + escape(u) + “@t=” + escape(t) + “@a=” +

escape(a);

window.open(‘<%= TagUrl %>’ + p, ‘MYXER’,

‘scrollbars=yes,menubar=yes,resizable=yes,toolbar=yes,location=ye
s,status=yes’);
</script>

The script has the effect of opening a new browser window, displaying the <%=TagUrl %>page and passing the “a”, “u”, and “t” attributes (which give the hostname, src url of the image, and alt tag form the image, respectively) to this page. “TagUrl” currently maps to http://www.myxertones.com/m2/add.aspx.

In this example, add.aspx is written so that it will attempt to download the image whose URL is given as a query string parameter (“u”), and if it succeeds, use the retrieved file similar to as if it had been uploaded directly from the end user's computing device. That is, the image can be manipulated, sent to a phone, shared with others, or be used in any of the ways that uploaded images can be used by the system 100.

Thus, the web browser extensions advantageously allow individuals to select content on the web and direct it to their own mobile devices. The web browser extensions also advantageously allow users to easily share web content with others via community features. For example, users can share the image on the system 100, leave comments on it, recommend it to others, etc.

In some examples, the user can crop a desired portion of the source image to be sent. Through the additional functionality described above, the user is provided with full access to other resources, such as an image editor that can be used to manually or automatically manipulate the image to improve its display on the mobile device. In some embodiments, an uninstall feature is provided to uninstall the web browser extension functionality.

Windows Shell Integration

In other examples, ending a ringtone to a phone using the system 200 utilizes a shell extension that works with operating systems such as Windows XP. This extension is registered so that it displays a new menu item, “Send As MYXER Ringtone”, to all supported file formats. When the user shows the context menu for any supported file, and then selects the Send As MYXER Ringtone menu item, the agent begins the process of uploading the specified song, automatically choosing a section to use as a ringtone, and notifying the user's mobile phone. The rest of the process can operate just as if the user had used the web interface to send a ringtone to their mobile device.

This method of sending a file has the primary advantage of appearing quicker to the user. With the web interface, information about the song (such as artist, song title, album, etc.) can not be detected until the audio file has been completely uploaded to the server. Because the client-side code for shell integration runs on the user's local system, it is able to extract information about the song and send that to MYXER before the full file has finished uploading. If the MYXER service can recommend splice points for the song, and the shell extension code on the local computer is capable of decoding the file format, only the portion of the song necessary for the ringtone need be updated to the server. Thus, the upload time is greatly reduced, and the ringtone appears on the mobile device faster.

In other examples, the windows shell integration makes use of a web service interface provided by the service to communicate with the system 200. This web service interface has function calls such as “SuggestRingtoneSegmentforSong( )” and “SendRingtoneToPhone( )”.

Mobilizing Media Content

In some examples, independent artists can add content available for mobile delivery through a third-party web service (e.g., on MYXERTones.com) from their own existing, unaltered web pages. This is achieved through the use of a special bookmark, running an applet (e.g., in JavaScript) and referred to herein as a bookmarklet, which invokes on their page a script that resides on the third-party server. The script of the bookmarklet when activated (i.e., selected from the user's browser) displays a small window in the user's browser viewing the artist's web page, the small window representing their store as illustrated in FIG. 11. This store can be synonymous with their primary profile.

If the user selects (e.g., clicks on) a feature from the small window, such as Mobilize, Lunch 1110 of FIG. 11, then draggable content that may include audio, video, and images available on the artist's web page stands out in some manner to the user. In some embodiments, the mobilizable content stands out as being labeled and unmasked by an otherwise obscured version of the artist's page displayed in the user's browser behind the mobilizeable content. Such modification of the artist's web page makes it clear to the user as to what content can and can't be made available for mobile download.

Content files that exist as hyperlinks or embedded media on the page in to the store window allows the store owner/artist to customize the title, description, and price of the content before submitting it to our site by clicking a Publish button. The Drag-and-Drop operation uploads that file to the third-party server for processing and the server responds with as much information as it managed to deduce from it in an effort to pre-populate some or all of the text boxes. The Publish button notifies the server to keep the file and make it a content record with the information the store owner filled in before clicking Publish. On success, the store refreshes with the new content in the category it belongs to Ringtones, Wallpapers, Videos, Full-Track, etc. The existing pieces of content can be edited in place without the use of post-back forms or ever leaving the artist's page with the store open on it.

In other examples, the store owner can create or edit a MYXERCode for mobile device users to easily get to their WAP storefront by texting the code to 69937 (MYXER). Any free content can be tested by clicking Send to Phone and typing in a phone number.

For example, the mobilization of web content includes a user first visiting a web page containing media content that the user intends to mobilize. For example, a web page is be hosted by an artist wishing to promote their artistic works in the form of images, audio files in the form of full tracks and/or snippets (e.g., ringtones), text, etc. A user accesses the webpage using a web browser. The user, viewing the webpage in the user's web browser, then launches a mobilization process that runs a separate process configured to mobilize such resources provided on or linked to from the visited webpage.

As a further example, such a mobilization process can be launched by a user action, such as clicking on a special bookmark provided in the user's web browser, while the browser is displaying the visited web page. In this example, the user's web browser must first be equipped with the special bookmark (referred to herein as a MYXER bookmark). The MYXER bookmark can be installed into the user's web browser through a one-time installation process. For example, the MYXER bookmark can be found by the user on a serving web page, then dragged and dropped into the user's web browser as would be a typical bookmark. The bookmark, rather than containing the address of a destination web page to which the browser should navigate, actually contains relatively short JavaScript code. This code provides a ‘hook’ into any target webpage that the user may later be viewing through the web browser when the bookmark is selected by the user.

As a further example, a technique for packaging JavaScript in a bookmark is referred to as a ‘bookmarklet.’ Normally, bookmarklets are limited to having a very small amount of code in them—much less than would be necessary for the exemplary mobilization process. This size limitation related to limits imposed by the browsers whereby the number of characters of script that they will support is limited. Since the code necessary to implement mobilization is typically much larger than what could be otherwise fit into a bookmarklet, a specialized technique is used to allow more code into the target webpage. In particular, a special (MYXER) bookmarklet contains a short code segment, referred to as a “bootstrap” code (also referred to as a first instruction). The bootstrap code is used to load one or more larger code files that can be dynamically injected into the web page from a third-party web site, such as the myxer.com website. The bootstrap code provided within the bookmarklet, when launched by a user viewing the target web page, can be configured to modify the Document Object Module (DOM) of the target web page, essentially adding a reference to a script hosted on a third-party site, such as myxertones.com. The user's browser sees the change to the target webpage, and behaves just as if the target webpage itself had originally referenced script from the third-party site. Such an approach allows an arbitrarily large amount of code to be loaded into the target page through a user's click on the pre-installed special bookmarklet.

Exemplary code associated with a bookmarklet includes:

javascript:void(s = document.createElement(%22script %22));
s.setAttribute(%22type%22, %22text/javascript%22);
s.setAttribute(%22charset%22, %22utf-8%22);
s.setAttribute(%22src%22,
%22http://localhost/magic20/scripts/myxer/?%22+ new
Date( ).getTime( ));
void(document.getElementsByTagName(%22head
%22).item(0).appendChil
d(s));

If this script is made the target of a hyperlink, e.g.,

<a href=“javascript: . . . ”>Click here to run Bookmarket</a>

Then the script will be run whenever the user invokes the bookmark (whether they click the link on a page, or save it to their Favorites folder and invoke it from their browser's menu, or whatever).

An image can be associated with this hyperlink, and the user invited to drag the image to their browser's toolbar (Firefox), or right click on it and select “add to Favorites” (Internet Explorer). For example:

<a href=“javascript:<bookmarklet code here>”>

<img src=“<img that begs to be dragged>”>

</a>

When invoked, the above script modifies the current document (whatever target web page the user is currently viewing in their browser) to add a reference to the script file, such as a URL (e.g., a reference to http://localhost/magic20/scripts/myxer/) to the “head” element of the page. (The bookmarklet code at the end of the above example referring to a getTime( ) function is optionally provided to prevent the user's browser from caching an old or otherwise outdated version of this script, e.g., a version that may have been used during development). Now that the target web page being viewed in the user's browser has been modified to have a reference to that script, the user's browser fetches the script indicated, any global code in it will be executed. The mobilization can be an interactive web based application that is controlled by a combination of JavaScript and server side C# code.

Once the visited web page is viewed in a user's browser, code can be implemented to automatically scan the contents of the visited web page to find media files. Once one or more media files are found, a user can drag one or more of the identified items and drop it onto a user interface (UI) (e.g., a mobile store manager). An exemplary code segment to perform this functionality is provided in Appendix A.

In other examples, when an item is dropped onto the UI, a web-accessible third party (e.g., MYXERTones.com) is sent a URL of the item. The media file is downloaded and imported into a process run on the third party server, such as MYXERTones. The UI is notified that this is done and is sent some basic information about the item. The replaces the normal step of using the MYXERTones web site to upload the file.

At this point the user is given a chance to alter the title, description and price of the item before making it available for mobile download from their mobile store.

Once the item has been added to MYXERTones it is available through the mobile downloads store, a SMS short code, a micro-WAP store, and/or from the MYXERTones web site itself.

In some examples, the code for the script file is actually dynamically generated on a third-party server (e.g., MYXER.COM), so that the code itself can be further modified, as may be necessary, to react differently depending on the environment in which it was invoked. For example, it might use the “referring URL” reported in the request to tailor the script for the web site being viewed by the user, or it might return different script for different people, using cookies from the requesting user's browser.

In other examples, the script that is returned to the user's browser viewing the target web page includes code configured to identify media content provided in or referenced by the target web page. For example, the code can be configured to crawl through the DOM of the web browser looking for interesting resources that are good candidates to be mobilized. But what's particularly advantageous about launching such code from the user's bookmarket is that:
(1) there is no browser installation necessary, as with a typical web browser extension (.XPI for Firefox, .EXE or .MSI for IE)—simply save the bookmarklet in the browser as is done for any typical bookmark;
(2) no installation means that there is no requirement for restarting the user's browser after saving the bookmark, meaning that the added feature is useful right away;
(3) by having the bookmarket as a stub and dynamically determining what script to return from the reference it places in the web page's code, the behavior of the additional code launched by the bookmarklet can be changed or otherwise updated at any point in the future without the user having to do anything;
(4) the bookmarlet works with virtually any web browser out there; and
(5) doesn't hit the third party web server (e.g., MYXER.COM) until the user actually selects it. (Oftentimes, as with the original MYXERMagic script for IE, a browser extension will make a request to the originating server even when the user is not intentionally activating the extension)

In some examples, the packaging a ‘hook,’ such as the bookmarklet provides a significant advantage of not requiring the user to download and/or install any application extensions into their browser. Such a download and install would otherwise be required for any user to add functionality to their web browser. Instead, the bookmarklet is ‘installed’ simply by having the user add it to the browser bookmarks or favorites. Although this approach is described in the context of mobilizing web content for mobile users, the technique of adding essentially unlimited code to a target webpage through a bookmarklet can be applied more generally.

Continuing with the illustrative embodiment, a user first loads the bookmark from a third-party web site as illustrated in FIG. 10. The user clicks on the bookmarklet while viewing a target web page, such as the exemplary web page illustrated in FIG. 11 and FIG. 12. This allows an arbitrary amount of JavaScript code to be loaded into the user's browser in the context of the target webpage. In some embodiments, the loaded JavaScript code scrapes and/or spiders the target webpage to identify potential resources (e.g., video clips, audio clips, images) the user may wish to mobilize. This process can be done using logic on the client (e.g., implemented in JavaScript) and/or logic on the third party server (e.g., logic that is invoked in JavaScript using cross-server AJAX requests to the third-party website).

In other examples, a simplistic approach to scraping and spidering the target site includes a process for crawling through the DOM of the target page to look for known file types. An exemplary screen shot of the results of such a process is shown in FIG. 11 and FIG. 12. In many cases, it is only after the resource has been retrieved that the content type can be determined for the media content (for example, by examining the MIME type returned by the remote server). So, for many types of referenced resources, it is necessary to actually ‘fetch’ the resource (or at least do an HTTP “HEAD” request) to know whether the file type is of a type that is a good candidate for mobilization.

Below is an exemplary code for identifying to a user to highlight media content, such as audio, images, and flash video, from a target web page and for extracting and sending any such selected media content. This is the data structure used to keep track of each potential piece of content we find when processing the page.

public class SpiderContentData
{

private string _url;
private string _title;
private MYXERContentType _type;
private string _id;
private string _nearestid;
private string _tag;
private string _attribute;
private string _value;
private string _innerHTML;

}

When requested by a client, the system can return an array of SpiderContentData that is a list of the content found on the page. The following exemplary code is the server side response to the request. The response is returned in JSON format, to be processed by JavaScript on the client.

private void pagecontent( )
{

string url = Request.QueryString[“url”];
if (string.IsNullOrEmpty( url ))
{

handleError( “url not specified.” );
return;

}
SpiderContentData[ ] list = SpiderContent.ProcessUrl( url );
SpiderContent sc = new SpiderContent( );
sc.JsonResponse( list, “MYXER Demo Page Content”, Request,

Response );

}

This is the method for identifying each piece of potential content as illustrated in Appendix B. The system 200 can tokenize the document then process each token (tag) in order. In this example, when the system 200 reaches a anchor (<a>) tag it looks at the target (href) of the anchor. The system 200 then builds a SpiderContentData object of each piece of content identified and add it to an array(list).

On the client, the list of content is processed and the objected on the page highlighted with an overlay. The example below shows how we process the anchor (<a>) tags from above. The way we identify the exact tag to highlight is by identifying it with the target (href) of the anchor tag.

var is = document.getElementsByTagName(‘a’);
for (var i = 0; i < pagecontent.items.length; i++) {

if (pagecontent.items[i].tag == ‘a’)
{

var a = pagecontent.items[i].value;
for (var j = 0; j < is.length; j++) {

var b =

is[j].getAttribute(pagecontent.items[i].attribute);

if (a == b)
{

var m;
if (pagecontent.items[i].content == ‘Video’)

m = myxer_overlay.overlay_image(is[j], 2,

pagecontent.items[i].link, 16, 50, pagecontent.items[i].content, ‘a’);

else

m = myxer_overlay.overlay_image(is[j], 1,

pagecontent.items[i].link, 0, 20, pagecontent.items [i].content, ‘a’);

myxer_overlay.overlays[count++] = m;

}

}

}

}

In some examples, the resources are often “wrapped” within applet containers that obscure the actual media type being served. A common case of this is encountered when using a Macromedia Flash applet (a .SWF file) to serve a video file (for example, a .FLV file). Often what happens is that a generic player applet (player.swf, for example), will be used in many, many different places on the internet, with a query string parameter or XML file being provided to tell it the location of the media which it should serve (for example, a list of .MP3 audio files, or an .FLV video file). Decoders can be provided that recognize common players (e.g., YouTube player, AOL Video player), and know how to locate the actual media file referenced by them. There are a large number of heuristics and smarts built in that make the system useful during mobilization.

When locating a resource that is a good candidate for mobilization, that resource is essentially imported into the existing MYXERTones system automatically. An in-browser user interface (such as a ‘store manager’) is provided allowing the user to control the process of what resources are turned into products in their mobile store, and allowing the user to edit them (change the title, description, price, choose the segment of an audio file to use as a ringtone, etc).

In addition to the automatic scraping and spidering of web pages to locate candidate resources, the user can choose to drag-and-drop content from the visited web site onto a store manager, which is configured to add such content to the mobile store. At least one approach uses a system referred to as overlays. Overlays are basically new rectangles that layered on top of an existing web page into which functions such as drag-and-drop ability, different cursor styles, and other visual effects are attached.

For example, in one embodiment, a semi-opaque animated .gif is layered over every candidate image on the page, which makes the images seem to shimmer, giving a visual clue to the user that they can choose to drag-and-drop that image into their store. In another embodiment, a semi-opaque grey screen is layered over the entire web page (which has the effect of making it dim), and overlay images are then created on top of that screen simply having a copy of the underlying image used as their background. This has the effect of dimming out all of the contents of the web page except those images automatically identified as candidates for addition to the store.

The user is able to access their store on any web page, so they can add contents to their store from many different web pages (and indeed even different web sites). The user can also choose to upload content to their store by giving a direct URL to it, or by uploading it from their computer.

Content that has been added to a store can have a custom MYXERCode associated with it, which is an SMS keyword that can be used to refer to the item when sending a text message to our shortcode 69937. MYXERCodes must all be unique, but they allow content that was added to a mobile store from a web page to be immediately available to non-web browsing users via SMS.

For example, a user can go to the Riley Martin site as illustrated in FIGS. 9-14 and drag an image onto my store manager. The user can then set a MYXERCode on that image to be “RILEYPIC.” Immediately, the user can say (for example, on a radio show) that people can “text RILEYPIC to 69937” to get the user's ringtone. Anyone with a capable phone will be able to get that image delivered to their phone, properly configured based on our device and carrier database logic.

System Requirements

There are various components that can make up the content mobilization system 100 of FIG. 1. These components can, for example, operate in multiple environments (e.g., different types of networks, different types of operating systems, different computing devices, different carrier networks, etc.). It is not intended that the system 100 be physically located on one discrete computer device, rather the various component parts can be networked (e.g., via a packet switched network, a local area network, etc.). Depending on the system 100 configuration, the individual components can be networked to decrease the time for ordering, processing, and/or delivering content to the mobile devices.

In some examples, the server-side components (e.g., media processing module 144, business logic module 146, etc.) run in an internet data center on common server hardware and operating systems.

In other examples, the wireless devices 112 of the system 100 are mobile devices. Since the system 100 can operate with any web browser via the bookmarks, the mobilization of media content advantageously does not require any special software to be installed on the mobile device. For example, the mobile devices that are internet-enabled can access any of the web sites and/or instructions associated with the system 100.

In some examples, the system 100 supports global network carriers including the major US carriers (e.g., AT&T, Verizon, T-Mobile, Spring/Nextel, etc.). The system 100 can also advantageously support other smaller and regional carriers without special code because the system 100 utilizes standard internet and/or mobile phone technologies for delivery of the mobilized media content.

In other examples, the system 100 includes a desktop agent module. The desktop agent module can be installed on a computing device 122. The desktop agent module can be installed by an end-user on their broadband-connected computer running an appropriate operating system (e.g., windows, linux, unix, Mac OS-X, etc.).

In some examples, the system 100 processes input media content files in various audio formats (e.g., mp3, windows media audio (WMA), a lossy digital audio compression scheme, such as M4A Advanced Audio Coding (AAC), a waveform audio (WAV), etc.). The system 100 can generate an output media content file in any format (e.g., MP3, WMA, M4A (AAC), a QCP file format is used by many cellular telephone manufacturers for providing voice ringtones, an adaptive multi-rate (AMR) format; AWB, standard MIDI file (SMF), etc.). For example, the system 100 can transform the media content file from mp3 format (i.e., input media content file) to wma format (i.e., output media content file). As other media file standards are developed, the system 100 can be modified to support these new standards.

In other examples, the system 100 can transform audio files, video files, and/or image files into different formats based on the requirements/needs of the mobile devices and/or the carrier networks. The system 100 can, for example, process input files in image formats such as graphics interchange format (GIF), JPG, portable network graphics (PNG), a bitmap image format that employs lossless data compression, bitmap (BMP), and/or any other type of format. As with other types of transformations by the system 100, the system 100 can transform these input media content files into any other format.

In some examples, the system 100 can transform input media content files in a variety of video formats such as MPEG2, MPEG4, FLV (Flash), and many others. The system 100 can generate output media content files (including audio and video) using a variety of codecs and/or packaging formats. For example, H.263 and MPEG4 formats are supported by the system 100.

In other examples, the input media content files (e.g., audio, images, video/multimedia, etc.) can be obtained from a user's personal computing device and/or media center. Generally, the input media content files are uploaded to the content mobilization server 140 before being transformed into an appropriate format for the destination mobile device (e.g., a ringtone, a screensaver, a video, etc.). The input media content files can be uploaded using a desktop web browser and the content mobilization server's web site using internet upload mechanisms. In some examples, the desktop agent module can be installed on the user's computing device to facilitate remote access to media content files on the computing device. The desktop agent module can be utilized to upload input media content files from the user's computing device using a wireless device as the user interface.

System Architecture

An exemplary architecture of the system 200 is illustrated in FIG. 2. In some examples, the system components are hosted by a web server, and run as a traditional web application. In this example, the primary entry points to the system 200 include: a WAP (or XHTML) interface 222 for access from mobile phones, an HTML interface 224 for access from desktop browsers, and a web service interface 226 for access from alternative user interfaces such as a native Windows interface 216, an SMS adapter interface 212, a telephony adapter interface 214, and/or a third-party website that offers the functionality of the technology. The security (e.g., authentication, authorization, access, etc.) can be, for example, performed at these entry points to the system 200.

In some examples, the WAP/HTML/Web Service interfaces use business logic in the form of a set of business objects, also hosted on the web server as illustrated in the business logic module 228, to provide core functionality to users. The business logic makes use of a database 252 which includes user information, segment records, information about file uploads, information about various device capabilities, information about WAP gateways used by cellular providers, logging and auditing capabilities, ecommerce data structures, and/or any other information associated with the mobilization of media content. One or more media processor components 246 can be, for example, hosted on the same machine, or on one or more remote machines within the web server's network. The media processor component 246 can be responsible for uploading files from users, extracting information from the files (e.g., the song they contain, the artist and album from which the song came, etc.), and transforming them from one file format to another. Multiple instances of this media processor component can be utilized in large deployments of the system 300, because the mobilization jobs can be CPU and/or network intensive.

In other examples, the media center agent 244 (also referred to as the desktop agent module) can be utilized on a user's home computing device and interface with the system 200 via the window shell adapter 216. The media center agent 244 can be make information about the user's media library available to the system 200 and can make the media content available when requested by the user. The media center agent 244 can be implemented as a small executable that runs on the home computing device.

In some examples, the media center proxy 242 represents the user's home media center agent 244 for the benefit of other server-side components. The system 200 can include a plurality of the media center proxy 243, because each subscriber may potentially have the media center agent 244 on their home computing device, and the media center agent 244 can make requests of the media center proxy 242. A farm of media center proxies can therefore be implemented and the load shared with traditional load balancing techniques to avoid scalability bottlenecks.

In other examples, the system 300 utilizes a network file system 254 to store the media content and/or the other the information associated with the system 300. This approach can scale better than putting all of the required files in a relational database. Another advantage is that more storage can be put online at any time, and support from a file system such as distributed file system (DFS) allows for flexibility in where the data actually lives. An additional advantage is that hierarchical storage can be utilized, whereby seldom-used or old files are backed up to cheaper storage without requiring the files path to change, can be easily implemented.

To increase redundancy and reduce the amount of local storage hardware required for typical operation, remote storage accessible via web service interfaces can be provided. Files uploaded to the system are copied to remote storage so that they may be independently backed up. If some or all of the local storage fails or becomes unreliable, the original source media files may be obtained from remote storage. This failover capability is implemented by logic in the web application that compares information stored in the local database with the contents of the local storage array. Using metadata in the database, the application is able to request any media file from remote storage should it fail to find it (or find it corrupted) locally. The fetch from remote store is automated and requires no administrative intervention.

When a system component wants to send a message to a user or to a user's phone, it can utilize the services of the messaging gateway 232. The messaging gateway 232 can be a packet modem, such as a general packet radio service (GPRS) modem attached to the serial port of a computer on the web server network, it may be an external short message service (SMS) gateway (e.g., Clickatell, CSoft, m-Qube, etc.) that serves as an SMS aggregator for delivering messages to phones on behalf of MYXER, it could use a dedicated connection to a carriers messaging infrastructure, and/or it could make use of a simple mail transfer protocol (SMTP) gateway to deliver the message using an email interface.

Web Interface

The web interface 222 can utilize web application development technologies, such as Microsoft's ASP.NET, and can run on an Internet Information Service web server. This example is a simple implementation choice, and the system 200 could be built using other technologies such as Java Server Pages (JSP) running on a web server such as Apache.

Authentication

The authentication requirements for the system 200 are specified in various configuration files maintained as a part of the web application. The users can be authenticated when they supply a valid username and password and/or by the use of any other type of authentication mechanism. These credentials can be checked against the database 252 and/or an external authentication service. If a user supplies valid credentials, a transient cookie can be returned to their web browser which allows the web site to recognize them as an authenticated user for a configurable time period.

Wireless Application Protocol (WAP) Interface

The WAP interface 222 can provide access to functionality from the mobile device. The WAP site can utilize ASP.NET mobile controls. Though called the “WAP” interface throughout this document, the WAP interface may in actuality be rendered to a target device as WAP1.x, WAP2.x, XHTML, HTML, or another markup language as appropriate for the device. The term “WAP” is used because it is generally a lower common denominator of device support, and it implies a simpler interface than the rich HTML supplied by the web interface.

In some examples, the design of the WAP site is similar to that of a stripped-down version of the HTML site. In other examples, the WAP site can be accessed in one of two different modes. First, a user can navigate directly to the WAP site (www.myxertones.com/wap, mxr.cc, or another alias), at which point they are prompted for username and personal identification number (PIN). Upon logging on, they are presented with a simple list of possible actions. Users that have the media center agent installed and running on their home PC can browse and search their home media center for supported media files such as songs, images, and video clips. Users may also view a list of recently-created ringtones and other content. In this mode, the WAP site functions as a mini-version of the web site.

In other examples, the users can be directed to the site by an SMS messages sent by the system 200 with a link to a particular ringtone. In this example, the URL requested by the phone is something like “/d1/4563/5355/”. When a user hits a link for a ringtone, it allows them to retrieve the ringtone without logging in. This makes the process of getting a ringtone work a lot more smoothly than when the user has to log in.

As a further example, the downloads.aspx page obtains control when a user requests a URL of the form given above. It looks up the ringtone whose ID is given as one of the query string parameters, validates that it was created for the user (whose ID is given as another query string parameter), and in one embodiment provides a link to the user from which the ringtone can be retrieved directly. In this embodiment the user is redirected directly to the ringtone file. In another embodiment, the downloads.aspx logic streams the requested media file directly back to the device (i.e., without providing a link to an actual media file). This latter embodiment has advantages, among them preventing the system from exposing information about the internal file system to the outside world.

Preventing Multiple Users from Accessing the Same Ringtone

In some examples, when the system 100 mobilizes media content (ringtones) for users, it provides the user with a URL with which they can access (download) the content, as described above. Because the system, in some examples, does not use traditional authentication on the download.aspx page for usability reasons, it needs some other way to make sure the same download is not accessed by other users. The ability to prevent multiple users from accessing the same ringtone is generally only necessary and useful when the ringtone is derived from material that is private to the user that requested it. In addition to private ringtones, the system 100 supports the concept of shared or public ringtones. Such ringtones need not be prevented from multiple downloads as described here.

To download a file, a user typically passes first through code associated with the download.aspx page. Before honoring a download request, this code first checks the database for the ringtone record associated with the requested ringtone. The ringtone record has a column that identifies the user that owns the ringtone, as well as a checksum value that is built to be unique to the device used by the owning user. If either (a) the user parameter supplied does not match the owning user specified in the ringtone record, or (b) the checksum calculated for the requesting device does not match the checksum for the user's device, the download is not permitted.

In some examples, the checksum for the user's mobile device is calculated based entirely on the user-agent string associated with the device. Because the user-agent string is not unique to a particular device (it is unique to a particular type of device, such as “Motorola V600 phone”), this checksum generation is not foolproof. However, there are normally other pieces of information included with a mobile download request that can be used to uniquely identify a particular phone. This information is provided in server request variables, such as “Subscriber-ID”. The subscriber ID information is provided to allow portals to personalize their appearance for a particular user, but they could be used for security as described here.

Essentially, the system 100 is locking the download such that it can only be accessed by the user's device, without requiring the user to enter their credentials before accessing the download. This is a tremendous usability improvement, as entering data on a mobile phone keypad can be difficult and error prone. In addition, it is faster. This same technique is applicable to downloads of any kind.

If the user obtains a new mobile device, ringtones they have previously downloaded will not be available for download with the new mobile device, because the checksum for their device will have changed. To download previously-created content to their new mobile device, then, manual intervention is required. In practice, the user notifies the administrator of the system 100, who resets the checksum on all of the user's ringtones.

Web Service Interface

In other examples, other user interfaces are built using the web service interface 226. A web service in the context of the system 100 can refer to any interfaces exposed programmatically to the internet. The services are exposed in various ways, including SOAP interfaces as well as simpler HTTP-based interfaces that use, for example, query string parameters or form field values to pass parameters.

In some examples, the web service interface 226 provides functionality similar to that provided by the WEB and WAP pages; namely access to user-specific information and functionality. The media center interface, currently implemented as host.asmx in the project, provides the interface used by the media center agent to request work items (and to report their completion).

SMS Gateway (Inbound)

In addition to using the web or wap sites to access the functionality of the system 100, users can also send SMS messages to the service for some application functionality. The system has registered the SMS Shortcode 69937 (“MYXER” on the phone keypad) in the United States, which allows any mobile phone user to send a text message to the application using that shortcode.

In other examples, the users can text “MYXER” in order to: search for a song on their home media center, send a link to MYXER to another number (invite a friend), request a particular piece of content identified by name or ID, send a message to (an)other MYXER user(s), adjust account settings, search for content in the MYXER catalog or on the web at large, and/or any of a number of other tasks.

Requesting a Particular Piece of Content

Content owners can prepare content to be delivered using the services of the system 200. This is done by first supplying either (a) an upload of the source file or (b) a link to the source file (such as an HTTP URL), and then associating a unique identifier with the content. The unique identifier may be generated by the system 200 automatically, or it may be supplied by the content owner. Once a piece of content has been prepared in this manner, a database record is created to maintain the mapping between identifier and content (or link to content).

When content is registered in this manner, it may be made available to other users. One way users can request the content is to send the unique identifier of the content to the MYXER shortcode. When this happens, the system 200 searches the database 252 for the associated content record, fetches the associated content, and then prepares and delivers it to the user using the mechanisms already described. This type of delivery allows content owners to distribute their content easily without requiring the users that receive the content to go to a web browser. For example, a local band might prepare a song with the system 200 and give it the unique identifier “Next Time”. Then, at a live show, they could tell the audience members to text the message “Next Time” to the MYXER short code (“69937”) to receive the song (or ringtone).

Searching Home Media Library

Searching the home media library can be done by texting the search string to the MYXER SMS phone number. Upon receiving the message, the SMS gateway uses the web service interface 226 to log the user on, request the search, and build a response SMS that is sent to the user.

There are three possible results from a search via SMS. First, the search string might match exactly one song. In that case, a ringtone can be prepared for the song, and the user can be sent a message with a link to the ringtone. Second, the search might fail, either because no match was found, or the host agent is not available. In that case, a failure error message is sent to the user's phone. Finally, the search can result in multiple results. In this case, the user is sent a message with a link to the WAP site's search page so that the user can choose from the results.

Subscribing/Unsubscribing from a Fan List

Content owners can also set up groups called fan lists. When a user signs up for a fan list, they may be sent messages and content from the associated content owners. Control over fan lists membership can be effected by sending the appropriate code to the MYXER shortcode.

Media Center Agent/Media Center Proxy

A user's media library can include songs, videos, animations, images, audio clips, or other media. The library can reside completely on the home PC, or can be spread between the PC and various other devices such as PDAs, portable music players such as iPods or another mp3 player, portable game devices such as PlayStation Portable, dedicated digital video recorders such as the TiVo, external media centers such as the Windows Media Center, digital cameras, and various other devices. Regardless of the location of the media and media library, the media center agent collects information about available media and provides access to it.

This component actively communicates with the system 200 by way of the Media Center Proxy's exposed web service interface 226. It constantly asks if there are any work items for it to process. The reason the media center agent uses the media center proxy's web service interface, and not vice-versa, is to deal with firewall issues on the agent's computer. Generally, a user will have their home PC behind a firewall that will prevent incoming connections. By implementing a protocol in which the agent uses a firewall-friendly interface (web services over HTTP) to request work to do, it is virtually assured that the agent will be able to communicate with the media center proxy.

Integration with Existing Desktop Search Engines

There are many third party search engines that can be installed on a home computing device. For example, Google has the “Google Desktop Agent” that allows a user to search the contents of their home computing device using an interface similar to the Google search engine for the web. Similar search engine tools are provided by Microsoft and Yahoo! All of these tools are intended to be used locally on the PC on which they are installed.

The media center agent 244 can use extensibility mechanisms provided by these search vendors to provide better search capabilities than the default directly searching built into it. The media center agent 244 accepts work items from the media center proxy 242 running in the system 200, which itself communicates with the user's mobile device using the WAP or SMS interface. By interfacing with the local search product, the media center agent 244 effectively remotes the search capabilities of the search product to the mobile phone without any changes to the search product itself. By supplying the appropriate options to the search product, the search can be restricted to media files supported by the system 200.

This setup provides a powerful way for users to move content from their home media center to their mobile device. First, they communicate a request to the system 200 using the WAP interface 222 and/or the SMS adapter 212. The system 200 uses the media center proxy 242 to forward the request to the media center agent running on the users home PC. The media center agent 244 uses the services of a local search engine, such as Google Desktop Search, to locate appropriate media files. The media center agent 242 then uploads the file to the media processor 246, which processes the file as appropriate and delivers it to the user's mobile device. The media content may be delivered directly over an existing WAP interface 222 (i.e., by providing a WAP page that contains a hyperlink that will download the file), or by delivering a new SMS message to the requesting phone. In other examples, the media content can be stored on the server for later download by the phone).

This search and download capability is very powerful, and can be applied to many different media formats. For example, a user may have a large library of digital images on their home computing device. Using the technique described above, a user could browse and search these images for a particular set of images, and have them delivered on demand to their mobile device. Because the mobile device will typically have orders of magnitude less storage than a home computing device, it will not generally be able to hold all of the digital images that can be held on the home computing device. Using this mechanism provides a great way to give the mobile device access to all of the contents of the home media center.

Scheduled Content Deliveries

Users may periodically wish to update their mobile device's wallpaper, ringtone, or audio files with other content that exists in their home media center. Instead of always having to actively request a particular piece of content to download to their mobile device, the users can set up scheduled delivers of content. For example, they can specify a folder on their home computing device called “Songs For Ringtones.” They can then provide this folder as a configuration setting to the media center agent 244, along with settings as to how often to deliver a new ringtone to the mobile device. At the appropriate time, the media center agent 244 can pick a song from that folder according to any of a number of algorithms and/or preferences, and send that song to the media center proxy 242 running in the system 200. The business logic module 228 can then send an SMS message to the user with a link to download the new content based on the business logic. In this way, the user is provided with fresh content on their mobile device without having to actively specify the content.

In another embodiment, the logic for scheduled deliveries may also be implemented completely in the business logic running in the system 200. For example, the user could use the WEB interface to specify settings for what kind of content, from which locations, they would like to have automatically delivered to their mobile device. In this embodiment, the user may specify not just content that lives on their home media center, but also content that lives in other network accessible locations, such as an online photo management site.

In another embodiment, the logic for scheduled deliveries may be implemented in the business logic running in the system 200, and may choose content for delivery that has been uploaded by other users, and that fits some criteria specified by the requesting user. For example, the user could use the web interface to specify that they would like to be sent a new ringtone from the “HipHop” genre every other day. The business logic on the system 200 would execute on a periodic basis, look for subscriptions that are overdue, select an appropriate piece of content, and effect the delivery of that content to the subscriber's mobile device.

Media Processor

One or more media processor components may be hosted on the same machine, or on one or more remote machines within the web server's network. The media processor component is responsible for uploading files from users, extracting information from them (such as the song they contain, the artist and album from which the song came, etc.), and transforming them from one file format to another. Multiple instances of this media processor component may be needed in large deployments, because the translation and upload jobs can be CPU and network intensive.

Identifying Audio Files

In some examples, the media processor 246 identifies the artist, title, album, and other identifying information for media content files entered into the system 200. An advantage is that the user population adds value to the system 200 through the collection of little bits of information that each user contributes, such as what segment makes a good ringtone for a given song, and organizing it in such a manner as to bring value to other users. Because the actual source data going into the system 200 often comes from an external source, the system 200 benefits from being able to take an arbitrary piece of media content and assigning a canonical label to it that is the same label as would be applied to the same content uploaded by a different user from a potentially different original source.

For example, suppose a user has a legally-obtained copy of the song “American Idiot” by Green Day that they obtained by capturing (i.e., “ripping”) the track from a CD they purchased. Then suppose another user purchases the same song in digital form from an online store such as Wal-Mart. Each of these users may upload the song independently to the system 200, but it is beneficial for the system 200 to be able to assign both of the media files an identical label so that information learned about one (such as what part of the song makes a good ringtone) can be applied to the other.

There are three basic approaches that are taken to get information about an uploaded file (and subsequently assign a canonical label) which are described below.

A. Metadata

Many audio formats, such as MP3, provide information about their contents in the form of metadata information included in the file's data. In the case of MP3 files, this information may be encoded with a format known as IDv3. When this metadata is present, the media processor 246 reads it out of the file and uses it to associate the file with a song record from the database.

B. Fingerprinting

Various algorithms exist for automatically identifying songs by creating an audio fingerprint. Companies such as 411 song (NMK, Inc., New York: http://www.411song.com/) and Gracenote (Gracenote, Inc., Emeryville, Calif., http://www.gracenote.com) provide web-based services for uniquely identifying songs based on, for example, fifteen seconds of audio. These services generally employ algorithms that identify discrete sonic patterns, i.e., instrumentation patterns such as kick drums or guitar, and/or vocal segments.

C. User Specification

If no metadata is found in a media file, and fingerprinting cannot identify the file uniquely, the end user may specify the information themselves using a web interface.

D. Applicability to Other Media Formats

While the system 200 typically identifies song (music) files, the identification process is equally important for formats such as images and videos such as television, movie, animation, and/or music video clips. In each of these examples, the same three techniques (metadata, fingerprinting, user specification) can be used to identify the media content.

Splicing and Processing of Audio Files

The media processor 246 is responsible for splicing and converting media files. The media processor consists of various command-line conversion utilities that move audio from one format to another.

The processing of the audio files to turn them into ringtones can be done logically as a three step process. First, the source audio file is converted to WAV format as a base for the rest of the process. Next, the section of the song to use as a ringtone is spliced out into a standalone WAV file. For example, a user specifies the temporal parameters of a song to specify the appropriate segment to be spliced from the song. Alternatively, the system 200 can elect a segment based on patterns, e.g., a time slice of the song that encompasses an instrumental break such as a bridge. In various embodiments, the system 200 elects the song segment based on user defined rules, such as “exclude vocals” using the above example. These first two conversion and processing steps are actually performed with a single invocation of the cliptowav.exe executable. Finally, the WAV file containing the ringtone section of the song is converted into the appropriate format. This last step is normally not done until the ringtone is actually requested by the user, because the system 200 optimally will choose the output format based on the device that requests the ringtone. Note that the output ringtone may be cached such that it does not need to be regenerated for each subsequent request.

Depending on which format is appropriate, one of several different encoder applications is used to convert the WAV file to the destination format. Among other conversion programs, the system 200 uses lame.exe for building MP3's, a Nokia utility for building AMR/AWB's (such as Nokia Multimedia Converter 2.0), a Yamaha utility for building SMAF's, a third-party encoder for M4A's (such as ImTOO Audio Encoder v2.0: http://www.imtoo.com), and so forth. Each of these applications is spawned as an external process, and these file conversion programs are available as shareware or freeware from the above vendors. Many other equivalent programs are commonly available and obtainable through the Internet.

Instead of spawning the conversion applications as separate processes, the system 200 can run conversions directly in the web service process and/or in a single external process. For example, using the MercuryXMS™ Mobile Video & Audio SDK from busineSMS.com, much of these conversion processes can be done in a single executable that takes advantage of the DirectShow functionality provided by Microsoft. In some configurations, it may be preferable to run the conversions in a single process rather than spawn external processes, because inline execution may result in better system performance.

User Accounts

The system 200, generally, uses traditional methods of maintaining information about users in its database. User accounts may be created explicitly using the sign up feature of the web site, or they may be created implicitly by the system the when a user uses features of the system. Each user account is represented by a single row in a dedicated UserTable of the database. One or more user profiles may be associated with each user account, each user profile being stored in a single row of a dedicated ProducerTable in the database.

Phone Validation

A mobile device number can be associated with a user account. This phone number is sent a text message when it is associated with a user account, and the text message contains an activation code that must be entered before the phone number is considered validated. The system 200 limits the number of messages that it will send to any unvalidated phone number to help avoid abuse of the system (for example, for text message spam, in which a user sends a large number of unwanted text messages to another person's phone).

Another way the system 200 can protect users from sending messages to other people's phones from the system 200 is that an “activation” message will only be sent once a day (or some other configurable period). So if a malicious person were trying to send a lot of text messages to another person using the system 200 registration process, the system 200 can effectively limit how often they can send to a single person.

In some embodiments, a total maximum number of activation messages sent to a number can be limited, i.e., ten. This means a total of ten messages can be sent to a given phone number before the phone number is locked out. This type of locking out is implemented by maintaining information in the user database about not just registered users, but the phone numbers that have been specified during the registration process. In a database record keyed by this phone number, the system 200 information such as a count of the total number of times we have sent a message to that number, the data and time of the last message sent, and other related information.

Invitations to System

Subscribed users of the system 200 can invite other people to the system using the HTML and/or WAP interfaces. The invitations may be sent either as email messages (to a ‘normal’ email account, or to an account that is supplied by the carrier and is automatically translated into a text message sent to the phone), or as text messages.

When new users are invited to the system 200 via text messages sent to their phone, they are given a link to a special page on the system 200 WAP site. Just by hitting this link, the system 200 has the advantage of learning what device they are using and what carrier they are using, using the techniques described elsewhere in this document. If the system 200 is unable to detect the device type of the user, or it detects it as an unsupported phone device, it logs an entry in a database that contains a lot of information about the request, including especially the “User-Agent” header passed in the request. The system 200 can periodically mine this database to determine which incompatible or unknown phones are hitting the site most frequently, allowing us to focus continued development more efficiently.

For example, if a new device from Nokia were released that the system 200 didn't recognize, it would write a record to the database whenever a user with that device followed any link to the WAP site (including an invitation link sent by another user, or an activation link sent as a result of starting the registration process, or any other hit). If the device were popular in the target market, it would receive a large number of hits from this phone, and the records for each hit could be grouped together on the basis of having an identical user-agent string. Periodically, such as at the end of the day or week, the database can be inspected, and the device(s) that have the most records in the database can be targeted for specific development to make them compatible. In addition to logging the information about the device in a database, the system 200 also sends an automated email message containing relevant information to a support alias that can be monitored to note unsupported phones (or phones with unknown features) as they are encountered.

In the mobile environment, where the mix of device types is constantly in flux, and it is very difficult to really understand which devices are being used by which demographics, having information about which devices are being directed to a WAP site, especially those that are not recognized or currently supported, is extremely valuable.

A “text message” can refer to an SMS message, a WAP Push message, and/or an MMS message. The types of messages supported by each user's device depends on the device model, the mobile operator with which they are subscribed, and/or other factors. As the system 200 records information about device model, mobile operator, and so forth in our database, the system 200 is able to make a determination as to the best (and most cost effective) method for sending messages to a user.

For example, sending SMS messages form the service to a user may cost two to fifteen cents per message. The cost varies according to many factors, including the SMS gateway (aggregator) used to send the message, the carrier that the recipient is subscribed with, and so forth. When the user's device can receive messages sent via SMTP email messages, though, the cost is essentially zero. So when it is possible to get messages to users using SMTP email messages, it is beneficial for us to do so. The real trick is in figuring out whether the recipient supports SMTP email.

To determine the preferred messaging format for a user, the system 200 relies on the database of device and carrier capabilities, as well as further information that may be supplied by the user. For example, the database of carrier capabilities contains entries that give information on how to send text messages to subscribers of that carrier via email messages. For example, most T-MOBILE customers will receive an SMS message whenever an email is sent to <phonenumber>@tmobile.net. So, a cost effective way of sending a text message to a T-MOBILE subscriber with a compatible phone is to send an email to 2025551212@tmobile.net instead of sending an SMS via an SMS gateway. The database contains records that specify rules for carriers, and specify the domain name of email gateways for their subscribers. This database can be updated whenever new information is learned.

In addition to holding information about SMTP (email) gateways that may be used instead of traditional text messages to deliver messages to phones, the carrier table may also contain a value that indicates the preferred aggregator (such as mBlox, CSoft, etc.) to use when delivering messages to phones on that carrier.

Phone and Carrier Detection

A. Detecting Phone Model

The system 200 can automatically detect the manufacturer and model of the user's mobile phone. An internal database correlates information provided by the phone's internal WAP or HTML browser software when connecting over a WAP link to known devices. A device may also be specified explicitly by a user using the web interface. Once the phone model (device) is known, the system 200 can determine the capabilities of that device based on information in our database. These capabilities include information such as whether or not the client is a mobile device, file formats supported by the phone for ringtones, limits to ringtone lengths, video formats (audio and video codecs, bitrate, etc.) supported, downloadable file limits, Java or other client-side capabilities, and/or message formats supported.

When a device connects to our website, it provides a unique “user agent” string that can be used to identify a particular model of phone and the version of software that is installed. A few exemplary user agent strings follow:
Nokia6600/1.0 (4.09.1) SymbianOS/7.0s Series60/2.0 Profile/MIDP-2.0 Configuration/CLDC-1.0
Samsung-SPHA700 AU-MIC-A700/2.0 MMP/2.0 Profile/MIDP-2.0 Configuration/CLDC-1.1
Mozilla/4.0 (compatible; MSIE 6.0; Windows NT 5.1; SV1; .NET CLR 1.1.4322)

Using the user agent string, the system 200 can determine the best ringtone format for a particular device. This data can be gathered from device manufacturers (using UAProf information), public databases, internal testing, and/or from users. Since manufacturers typically base new phones on previous devices, it's possible to predict the capabilities of a device based on previous similar devices released by the manufacturer. By parsing the useragent string, the system 200 can find a similar device in the database. Here's a hypothetical example: Nokia releases version 2 of the Nokia 6600, the new user agent string would look something like this: “Nokia6600/2.0 (5.02.1) SymbianOS/7.0s Series60/2.0 Profile/MIDP-2.0 Configuration/CLDC-1.1”, while this might not be in the system 200 database, if it breaks down the useragent string, the system 200 would be able to find the entry in the database for the Nokia6600/1.0.

B. Logging of Unknown Devices

When an unknown device connects to the system 200, or a device for which the system 200 has incomplete configuration information (such as supported ringtone format, supported video codecs, max file size, etc.), information about the device is logged to a database so that we can add the missing information to the device database. Human interaction is also used to determine cases where device configuration information is missing, incomplete, or inaccurate. For example, we maintain a feedback loop via email with our users in order to allow them to alert us of such situations. The process of adding a new device to the database can be automated, using a tool that queries various repositories for device information (include the UAProf profile from the manufacturer) and inserts the information into our database.

C. Database Entries

The device database contains three primary tables. These tables are:

DeviceTable, ManuTable, UserAgentTable. The UserAgentTable maps user agent strings to entries in the DeviceTable, while the ManuTable is a simple list of manufacturers referenced by the DeviceTable.

The DeviceTable has columns that contain information specific to the device's configuration and capabilities, such as Manufacturer (string); Model (string); RingtoneFormat (string); RingtoneVerified (bool); RenderType(string); RenderMime(string); RtSizeKb (int); WpSize (int); WpHeight(int); WpWidth(int); WpFormat(string); DRMType(string); DRMEncoding (string); VideoFormat (string).

For the Nokia 6600, the database entry would be:

Manufacturer (“Nokia”); Model (“6600”); RingtoneFormat (“AWB”); RingtoneVerified (True); RenderType(“wm113”); RenderMime(“image/vnd.wap.bmp”); RtSizeKb (60); WpSize (0); WpHeight(143); WpWidth(174); WpFormat(“JPG”); DRMType(“none”); DRMEncoding (“ ”); VideoFormat (“None”).

D. Detecting Mobile Operator

The system 200 automatically detects the company associated with the user's mobile phone. Normally, operators use a Home Location Register (HLR) lookup to determine a phone's mobile operator (based on the phone number). This requires the use of private interfaces that are not exposed to external companies. The system 200 detects the mobile operator by examining HTTP variables passed with a request to the system WAP site. One of these identifies the WAP gateway used by the phone to connect to the site.

In general, mobile operators use internal WAP gateways to provide their subscribers with access to internet resources. The IP address of the WAP gateway used by a connecting device is provided with each request to the WAP server. The system 200 maintains a database of known WAP gateways, and associates these with mobile operators. Once an entry for a WAP gateway exists in our database, we are able to determine the operator of which the connecting device is a subscriber.

Typically the domain name of the WAP gateway is a good hint to the user's carrier. If the specific IP address of the WAP gateway is not known, the system 200 can use the domain name to determine the carrier. This carrier information is then stored in the user's account record. The system 200 can use the carrier information to determine the based why to send an alert to the user's device either thru an email that is delivered as a text message, sending an alerts to the user thru a modem connect to the carriers network, and/or determining which SMS gateway provider to use.

In some cases, simply looking at the WAP gateway IP address is insufficient to determine the carrier for the phone being used. In these cases, other HTTP request variables may be used to identify the carrier.

Content Repurposing

Because different mobile devices support different formats and bitrates for audio files used as ringtones, it is sometimes necessary to translate the format of a source audio file so that it can be properly used on a desired target device. Since the system 200 chooses the format after processing the segment, it becomes simple to reformat the segment.

The system 200 can include a proprietary translation engine that accepts as input audio files in all major audio formats (MP3, M4A, WAV, WMA, etc) along with parameters that identify the desired output file format, encoding bitrate, number of channels, and other information. It decodes the source file into an intermediate representation (which may be simple pulse code modulation (PCM), or may be another intermediate format), and re-encodes the audio into the destination format. The pluggable architecture of this translation engine allows new encoders and decoders to be created that have no knowledge of file formats other than the intermediate format used by the engine.

Because the system 200 knows the specific target device for the ringtone, it is able to intelligently convert audio of any supported input format into a format appropriate for that device without any user interaction. The actual encoders/decoders used may be off-the-shelf components, such as those written to work within Windows Media/Microsoft DirectShow.

Intelligent Splicing

Mobile phone ringtones are often short segments of songs. A typical ringtone will be from 15-30 seconds, while a typical popular song might be three and a half to four and a half minutes.

When a user specifies a song that they want to use as a ringtone on their mobile device, the system 200 can automatically choose a short segment of the song to use. This automatic splicing of the song is performed using song identification and a proprietary database containing information about songs and appropriate ringtone segments. Song segment information includes the start and stop points (in milliseconds relative to the beginning of the complete song) to be used for the ringtone. Optionally, fading information can also be included.

A ringtone segment record might therefore have information like: Song: American Idiot; Artist: Green Day; Length: 3:41; Ringtone_Start: 15000; Ringtone_Stop: 35000; FadeIn_Time: 1000; FadeOut_Time: 1000. The preceding record specifies a ringtone based on a segment of the song “American Idiot” by Green Day, the ringtone starting 15 seconds into the song, ending 35 seconds into the song, and having a one second section at the beginning and end of the ringtone during which the audio should be faded in and out, respectively. What constitutes an appropriate ringtone is very subjective, but the system 200 makes good choices based on: (i) expert human input, (ii) collective input from users, and/or (iii) custom algorithms that analyze a song and choose segments based on any of a number of criteria, for example user defined properties, vocal patters, and the like.

Expert Human Input

In some examples, the system 200 uses a group of people, called ‘ringtone editors’, to define ringtone segments for popular songs. This group of people use a software program that allows them to manually choose segments of songs. For example, they listen to a song, and when a desired “start point” occurs they click a button. Then when the ‘end point’ occurs, they click the button again. They can then preview their selection and modify it by moving the start and end points. When they are satisfied with their selection, they click another button that submits information about the song (i.e., artist, song title, album) along with the start and end points, to the system 200 splice database. (Fading information can also be gathered in a similar fashion). Multiple start and end points can be used, effectively generating multiple segments that are spliced together to create the ringtone. In certain embodiments, the tempo may also be adjusted.

Optionally, an existing audio playback program can be used, and the user can specify the start/stop/fadein/fadeout points manually. These numbers can be entered into the database using something as simple as the SQL Query Analyzer.

Collective User Input

Even when no expert human has suggested a ringtone segment, a ‘layperson’ may choose start and stop points (and fading information) to use. They may use a tool provided by the system 200 for that purpose, or they may already have spliced a segment of a song for use as a ringtone using some other means. The system 200 includes an online ringtone editor that may be used to select the start and stop points. It displays a graphical representation of the uploaded sound file, and lets the user click on the desired start and stop points.

Whenever a user manually chooses start and stop points, the system 200 records an entry in the ringtone segment database containing the song, start and stop points, and other associated metadata.

When another user uploads the same song to the system 200, the web interface allows them to preview and/or select segments that were created by other users with the same song. If the user selects the ‘auto-generate’ option, the most popular existing segment will be used. When multiple segments are defined for the same song, the system 200 uses a proprietary algorithm to decide the best segment from the choices. This algorithm creates a score for each segment based on the actions of the other users.

One way to do this is to record when a user previews a song segment and record whether or not they then decide to download it to their phone. If they decide in favor of downloading the previewed segment, that action is considered a vote ‘for’ the segment, and an appropriate counter is incremented in the database record containing the segment. If they decide not to download the previewed segment, it is considered a vote ‘against’ the segment, and a different, appropriate counter is incremented in the segment record.

When multiple segments (potential ringtones) exist for a given song, the user may be presented with a choice between more than one of them.

Each song segment is stored in a database. More preferably, metadata about a song and appropriate ringtone segments are stored in the database. Storing just the song metadata. Along with start and end points, a preview count and an accept count are kept for each segment. When a user previews a segment on the web site, the preview count is incremented. If they decide to use the segment to make a ringtone the accept count is incremented. In one embodiment, a user must upload a song or otherwise provide verification of ownership in order to preview a segment generated from that song.

When the system 200 is asked to automatically generate a ringtone for a song, it enumerates all of the segments for that song from the database. A score for each segment is generated using a formula that uses both the accept count and the preview count. The segment with the highest score is deemed to be the “best” and is used to create the ringtone. In one embodiment, this formula provides for summation of the positive and negative preview and accept counts, which is stored as metadata about that song segment.

Automated Algorithms

In cases where no expert ringtone editor has chosen an appropriate segment of a song to use as a ringtone, and the user is unable or unwilling to choose splice points themselves, the system 200 employs a proprietary software algorithms to intelligently choose song segments. These algorithms analyze song files using a wide variety of heuristic information about musical sound. For example, the algorithms can use a technique known as beat-slicing to infer the tempo of a rhythm-based song. For example, kick drums have a unique signature in a sound file that can be easily detected, which is used in modern audio processing equipment to speed up or slow down audio streams without affecting their pitch; the process is called beat-slicing. Information about the tempo, along with additional analysis, may allow the song to be split into segments corresponding to longer sections. As much popular (and especially rock) music uses the familiar “verse-chorus form,” this technique can often detect the points in the song at which verses and instances of the chorus occur. There are many varieties of the “verse-chorus” form, and other forms in popular use today, that may be detected. Regardless of the form of a song, different sections are often easily identified by detectable shifts in amplitude, predominant frequency range, and pattern recognition techniques, as well as a variety of other techniques familiar to audio engineers.

Most of the web pages associated with the system 200 are generated within a modern web server environment such as ASP.NET that allows programmatic processing of all page requests. The ‘code’ for a web page in this context relies to the server-side code-behind associated with processing an HTTP request and generating an appropriate web page. Oftentimes, we make reference to such statements as “The page determines the identity of the calling user.” as short-hand for “the code associated with the HTTP request for a given page determines the identity of the calling user.”

Video/Image Processing

Video processing can be performed with “MercuryXMS™ Mobile Video & Audio 2006 SDK” from busineSMS software. This SDK is primarily a wrapper around the DirectShow video support provided by Microsoft Windows Media Player. The system 200 can accept input video in formats such as .AVI, .WMV, and others, and produce 0.3GP video using acceptable mobile video formats like MPEG4, H.263, and so forth. The video transcoding is plugged into the media manager of the system 200, and videos are processed throughout the system in much the same way as ringtone (audio) and wallpaper (image) files.

In other examples, the system 200 allows users to upload a video in a supported format and then send it to their own phone or share it with others. When delivering video to a destination mobile device, the same paths are used as when delivering ringtones and images. That is, a device database dictates what the output format of the video should be (bitrate, audio and video codecs, etc.) and the video is processed “on-the-fly” for the destination device. (In some embodiments, the output of each on-the-fly transcoding is temporarily stored in a cache memory to speed up subsequent deliveries.

Different mobile devices have different display sizes and aspect ratios, depending upon the type, make, and model of the device. When processing images, users can upload images of virtually any size, aspect ratio, and source format into the system 200. The system 200 includes image manipulation algorithm that provide appropriate conversions to deliver the image in a usable format to an any end user that downloads the image to their mobile phone for use as a screensaver, wallpaper, etc

In general, a source image may be a JPG, GIF, or other image, with a source region that describes an “area of interest” of said source image. A destination image size can be defined that specifies a required output image size. The image manipulation algorithms produce a destination image having a destination image size. In some embodiments the destination image size is produced favoring a source region that it is likely to include the a prominently featured region of the image.

Appendix C includes a source code listing for just such an image manipulation algorithm providing intelligent image manipulation.

Dynamic MYXERCodes

Dynamic MYXERCodes can be provided to allow a value added service provider to offer personalized mobile content using the system 200 to convert, deliver, and/or optionally bill for the content. At a high level, the system 200 is given a unique service identifier (in the form of a custom MYXERCode) and an “opaque” key. The service identifier and key may be input into the system in one of many different ways. For example, they might come in a single text message (SMS) sent from the end user (e.g., “GET CUSTOM 1234”). They may come from a web service request by the service provider (e.g., a SOAP message containing the information as relevant parameters). The system 200 uses the service identifier to find information about the configured service provider (partner).

One piece of information associated with each configured service provider is the location of an HTTP endpoint from which custom content in the source format may be obtained. The system 200 makes a request to the HTTP endpoint configured for the service provider, passing it the opaque key received in the first step. The service identifier may also be provided in order for a single HTTP endpoint to handle multiple different services. The service provider's endpoint returns an appropriate source media file, ostensibly personalized for the requesting user based on the supplied opaque key. The system 200 processes the source media file and effects delivery of an appropriate derivation of it to the destination mobile phone. This is done using the same (or nearly the same) mechanisms as are used when delivering static source media content to a user's phone.

As an example a company offering “super-personalized content and services” may use audio splicing technology to personalize a voicemail message. Dynamic MYXERCodes will allow such companies to create content for mobile phones, such as ringtones, that can be purchased using premium SMS right from their vary own website. In this example, the company would register a custom service identifier with MYXERTones, say, “VTALK.” They would then produce a unique opaque key for each user of their web site, perhaps using a simple integer for each user. They would then instruct the user of their website to “text VTALK 123 to 69937 to purchase your custom ringtone for $1.99”. Since MYXERTones will get the message that is sent to 69937, and since MYXERTones knows that the service identifier of VTALK is registered to the company's servers, it can invoke the appropriate HTTP endpoint registered for the company, and give it the supplied key (123), in order to receive the source content. The content is then delivered and billed as normal.

Dynamic Hierarchical Storage

Dynamic hierarchical storage is provided in some embodiments, using storage service, such as Amazon S3, to hold copies of source media files uploaded to the system. Each file uploaded to the system is recorded in an UploadTable of the database. Among other information, each row in the UploadTable has a globally unique identifier (GUID) assigned to it at the time of upload. This GUID is used to determine the location at which the source media file is stored, both on the local file system as well as in the remote storage accessible via a web service interface.

On the local filesystem, the file can be stored in a filesystem directory composed by appending a string derived from the GUID to a root upload file path supplied by a configuration file setting. If the string representation of the GUID were 62887a4c-3f41-441e-83b7-0fda73d7a1f7, then the path appended to the root upload file path would be: /62/88/62887a4c-3f41-441e-83b7-0fda73d7a1f7. By adding two directories to the beginning of this segment of the path, we limit the number of subdirectories in any given directory to 256 (“00” through “ff”), which improves the efficiency of both manual and programmatic file operations.

A copy of the same media file is also stored in the web storage solution (e.g., Amazon S3), using the GUID as the identifying key for the file. Because the UploadTable maintains the GUID for every file ever uploaded to the system, application logic is able to locate the associated file quickly on the local filesystem simply by building a path string as described above. If the file is not found at the location implied (perhaps because the disk is corrupt, the file was accidentally deleted, or the file was intentionally deleted after a period of inactivity to save local disk space), application logic can find a copy of it on the permanent remote web storage.

In practice, the local copy of uploaded files is deleted after a configurable period of time has elapsed since last accessed. If the upload is subsequently required to fulfill a user request, it is obtained from remote web storage, copied into the appropriate location on the local file system, and the operation continues as normal.

It is not necessary for the core application logic to be aware that remote storage is being used. By isolating the access to the actual file system to a small component of source code (the media manager), an essentially unlimited, permanent remote storage can be added without changing any of the existing application logic. This has significant advantages, because new servers can be brought online (for example, a second web server, or a replacement web server in the event of a disaster), and all content that had been previously uploaded will be seamlessly pulled down to the new server as required.

Although the exemplary embodiments of the technology described herein relate to the identification of media content on target web pages and its mobilization, the technology has much broader applicability. For example, the bookmarklets can be used to associate any additional code with a target web page viewed through a user's web browser. Such code can be used to modify or otherwise manipulate contents of the web page, including the web page itself; to obtain information from the web page; to provide a user interface for accessing and/or manipulating the web page and/or any of its contents; and combinations thereof. The contents of the web page can include any elements that may be associated with a web page. Such elements include, but are not limited to text; images; video; audio; animation; and applications, such as video games. One or more of the elements can be in a compressed or uncompressed format. Audio can include full track audio files or snippets, such as those used in ringtones. Video and animation may include full track vide files or snippets. Web browsers include any such application allowing a user to view or otherwise access web-hosted material. Such browsers include standard web browsers hosted on computers, and specialized browsers adapted for viewing web content on a smaller format, such as provided in a mobile or handheld device, such as a mobile phone, personal data assistant, or pocket PC. Mobilization of web content refers generally to making such content accessible to a mobile device. Mobile devices can include mobile phones, personal data assistants, pocket PCs, game consoles, computers, and wireless systems in general.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site. Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The requestor device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

From the foregoing, it is clear that a number of embodiments of the instant invention have been described. Nevertheless, it will be understood that various modifications may be made without departing from the spirit and scope of the claims, which are considered equivalent thereto. For example, the system may be used with various international wireless standards. Accordingly, other embodiments are within the scope of the following claims.

What is claimed is:

1. A method for mobilizing media content, the method comprising:
transmitting a bookmark to a requester device, the bookmark comprising a first instruction for directing the requestor device to request a second instruction;
receiving a request from the requestor device for the second instruction, the request based on the first instruction; and
transmitting the second instruction in response to the request from the requestor device, the second instruction directing a modification of a user display associated with the requester device to facilitate mobilization of media content.

2. The method of claim 1, further comprising receiving a request for the bookmark from the requester device.

3. The method of claim 1, wherein the first instruction is smaller than the second instruction.

4. The method of claim 1, wherein the modification of the user display comprises dynamically injecting a third instruction into the user display.

5. The method of claim 1, wherein the modification of the user display comprises modifying a document object model (DOM) of a web page displayed on the user display.

6. The method of claim 1, wherein the bookmark comprises an applet.

7. The method of claim 1, further comprising mobilizing media content associated with the user display based on the second instruction, the mobilized media content being easily portable to a mobile device.

8. The method of claim 7, further comprising transmitting the mobilized media content to the mobile device associated with the requestor device.

9. The method of claim 7, further comprising the mobilizing the media content further comprising transforming and/or modifying the media content.

10. The method of claim 9, further comprising the transforming the media content from a first media format to a second media format based on configuration information associated with the mobile device.

11. The method of claim 10, further comprising automatically determining the configuration information associated with the mobile device based on a type of the mobile device, a setting of the mobile device, and/or a network associated with the mobile device.

12. The method of claim 7, further comprising the mobilizing the media content further comprising:
retrieving the media content from a web page associated with the user display;
selecting a time interval of the media content based on an audio segment and/or a video segment; and
transforming the media content into the mobilized media content for the mobile device based on the selected time interval and/or configuration information associated with the mobile device.

13. The method of claim 12, further comprising selecting the time interval of the media content based on the audio segment, the video segment, a user selection, a user preference, and/or a pre-defined media segment.

14. The method of claim 7, further comprising storing the mobilized media content.

15. The method of claim 14, further comprising providing access to the stored mobilized media content to a plurality of users via mobile devices.

16. The method of claim 7, wherein the media content comprises an image, a video, audio, a ringtone, and/or any combination thereof.

17. The method of claim 1, wherein the first instruction does not direct the modification of the user display associated with the requestor device to facilitate mobilization of media content.

18. The method of claim 1, wherein the user display displays a web page.

19. A method for mobilizing media content from a web page, the method comprising:
visiting a web page using a web browser, the visited web page comprising media content;
selecting while visiting the visited web page a bookmark stored in the web browser, the bookmark comprising a first instruction processed in response to selection thereof;
obtaining a second instruction from a web accessible server based on the first instruction; and
loading into the web browser the second instruction in a context of the visited web page.

20. The method of claim 19, further comprising transmitting a mobilization request for a specified media content, the mobilization request comprising information to associate the specified media content with a mobile storefront.

21. The method of claim 19, further comprising the loading into the web browser the second instruction further comprising dynamically injecting the second instruction into the visited web page based on the bookmark.

22. The method of claim 17, wherein the second instruction comprises an applet.

23. The method of claim 22, wherein the applet comprises javascript.

24. A computer program product, tangibly embodied in an information carrier, the computer program product including instructions being operable to cause a data processing apparatus to:
transmit a bookmark to a requester device, the bookmark comprising a first instruction for directing the requester device to request a second instruction;
receive a request from the requester device for the second instruction, the request based on the first instruction; and
transmit the second instruction in response to the request from the requestor device, the second instruction directing a modification of a user display associated with the requestor device to facilitate mobilization of media content.

25. A system for mobilizing media content, the system comprising:
an access point module for:
transmitting a bookmark to a requestor device, the bookmark comprising a first instruction for directing the requester device to request a second instruction, and
transmitting the second instruction in response to a request from the requestor device, the second instruction directing a modification of a user display associated with the requester device to facilitate mobilization of media content; and
a business logic module for receiving the request from the requestor device for the second instruction, the request based on the first instruction.

26. The system of claim 25, further comprising a media processing module for mobilizing the media content based on the second instruction, the mobilized media content being easily portable to a mobile device.

27. The system of claim 25, further comprising the access point module for transmitting the mobilized media content to the mobile device associated with the requester device.

28. The system of claim 27, wherein the mobile device is the same as the requestor device.

29. The system of claim 25, further comprising a media processing module for:
retrieving the media content from a web page associated with the user display;
selecting a time interval of the media content based on an audio segment and/or a video segment; and
transforming the media content into the mobilized media content for the mobile device based on the selected time interval and/or configuration information associated with the mobile device.

30. The system of claim 25, further comprising a storage module for storing the mobilized media content.

31. A system for mobilizing media content, the system comprising:
means for transmitting a bookmark to a requestor device, the bookmark comprising a first instruction for directing the requestor device to request a second instruction;
means for receiving a request from the requester device for the second instruction, the request based on the first instruction; and
means for transmitting the second instruction in response to the request from the requestor device, the second instruction directing a modification of a user display associated with the requester device to facilitate mobilization of media content.
